(19) United States
(12) Patent Application Publication
(10) Pub. No.: US 2026/0016924 A1
(43) Pub. Date: Jan. 15, 2026

(54) ELECTRONIC DEVICE AND METHOD FOR IDENTIFYING TOUCH INPUT

(71) Applicant: Samsung Electronics Co., Ltd., Suwon-si (KR)

(72) Inventor: Woosang PARK, Suwon-si (KR)

(21) Appl. No.: 19/335,686

(22) Filed: Sep. 22, 2025

Related U.S. Application Data
(63) Continuation of application No. PCT/KR2024/004917, filed on Apr. 12, 2024.

(30) Foreign Application Priority Data
Jun. 5, 2023 (KR) 10-2023-0072469
Jul. 19, 2023 (KR) 10-2023-0094206

(51) Int. Cl. G06F 3/044

(52) U.S. Cl. CPC G06F 3/0448; G06F 2203/04107

(57) ABSTRACT

A method performed by an electronic device is provided. The method includes identifying, based on a first capacitance value identified through a first electrode of the electronic device, that a distance between an external object and the first electrode is within a reference distance, changing, based on identifying that the distance between the external object and the first electrode is within the reference distance, a state of a second electrode of the electronic device from an inactive state to an active state, identifying, based on a first capacitance value and a second capacitance value identified through the first electrode and the second electrode, a touch input by the external object, and identifying, based on a first capacitance value, whether the touch input is maintained.

### CROSS-REFERENCE TO RELATED APPLICATION(S)

This application is a continuation application, claiming priority under 35 U.S.C. § 365 (c), of an International application No. PCT/KR2024/004917, filed on Apr. 12, 2024, which is based on and claims the benefit of a Korean patent application number 10-2023-0072469, filed on Jun. 5, 2023, in the Korean Intellectual Property Office, and of a Korean patent application number 10-2023-0094206, filed on Jul. 19, 2023, in the Korean Intellectual Property Office, the disclosure of each of which is incorporated by reference herein in its entirety.

### BACKGROUND

### 1. Field

The disclosure relates to an electronic device and a method for identifying a touch input.

### 2. Description of Related Art

An electronic device receives a touch input based on a change in capacitance. The electronic device determines that the touch input is received even when a foreign substance including moisture is in contact with the electronic device. A method to prevent such malfunction of the touch input is required.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for identifying a touch input.

Additional aspects will be set forth in part in the description which follows and, in part, will be apparent from the description, or may be learned by practice of the presented embodiments.

In accordance with an aspect of the disclosure, an electronic device is provided. The electronic device includes a substrate comprising a first surface and a second surface opposite to the first surface, a first electrode on a first area having a first size in the first surface, a second electrode on a second area having a second size greater than the first size in the second surface, touch sensor circuitry connected with the first electrode and the second electrode, memory, comprising one or more storage media, storing instructions, and at least one processor comprising processing circuitry communicatively coupled to the touch sensor circuitry and the memory, wherein the instructions, when executed by the at least one processor individually or collectively, cause the electronic device to identify, based on a first capacitance value identified through the first electrode, that a distance between an external object and the first electrode is within a reference distance, change, based on identifying that the distance between the external object and the first electrode is within the reference distance, a state of the second electrode from an inactive state to an active state, identify, based on a first capacitance value and a second capacitance value identified through the first electrode and the second electrode, a touch input by the external object, and identify, based on a first capacitance value, whether the touch input is maintained.

In accordance with another aspect of the disclosure, a method of an electronic device is provided. The method includes identifying, based on a first capacitance value identified through a first electrode of the electronic device, that a distance between an external object and the first electrode is within a reference distance, changing, based on identifying that the distance between the external object and the first electrode is within the reference distance, a state of a second electrode of the electronic device from an inactive state to an active state, identifying, based on a first capacitance value and a second capacitance value identified through the first electrode and the second electrode, a touch input by the external object, and identifying, based on a first capacitance value, whether the touch input is maintained.

In accordance with another aspect of the disclosure, one or more non-transitory computer-readable storage media storing one or more computer programs including computer-executable instructions that, when executed by at least one processor of an electronic device individually or collectively, the at least one processor with touch sensor circuitry connected with a first electrode and a second electrode, cause the electronic device to perform operations are provided. The operations include identifying, based on a first capacitance value identified through the first electrode, that a distance between an external object and the first electrode is within a reference distance, changing, based on identifying that the distance between the external object and the first electrode is within the reference distance, a state of the second electrode from an inactive state to an active state, identifying, based on a first capacitance value and a second capacitance value identified through the first electrode and the second electrode, a touch input by the external object, and identifying, based on a first capacitance value, whether the touch input is maintained.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A illustrates an example of touch sensor circuitry connected to one electrode according to an embodiment of the disclosure;

FIG. 2B illustrates an example of a change in capacitance magnitude for identifying a touch input according to an embodiment of the disclosure;

FIG. 3A illustrates an example of touch sensor circuitry connected to one electrode according to an embodiment of the disclosure;

FIG. 3B illustrates an example of a change in capacitance magnitude for identifying a touch input according to an embodiment of the disclosure;

FIG. 4A illustrates an example of touch sensor circuitry connected to a plurality of electrodes according to an embodiment of the disclosure;

FIG. 4B illustrates an example of an operation of touch sensor circuitry connected to a plurality of electrodes according to an embodiment of the disclosure;

FIG. 4C illustrates an example of an operation of touch sensor circuitry connected to a plurality of electrodes according to an embodiment of the disclosure;

FIG. 5A illustrates an example of touch sensor circuitry connected to a plurality of electrodes according to an embodiment of the disclosure;

FIG. 5B illustrates an example of an operation of touch sensor circuitry connected to a plurality of electrodes according to an embodiment of the disclosure;

FIG. 5C illustrates an example of an operation of touch sensor circuitry connected to a plurality of electrodes according to an embodiment of the disclosure;

FIG. 6A illustrates an example of first capacitance and second capacitance for identifying a touch input according to an embodiment of the disclosure;

FIG. 6B illustrates an example of first capacitance and second capacitance for identifying a touch input according to an embodiment of the disclosure;

FIG. 7A illustrates an example of interference by at least one component according to an embodiment of the disclosure;

FIG. 7B illustrates an example of interference by at least one component according to an embodiment of the disclosure;

FIG. 8A illustrates an example of shapes of a first electrode and a second electrode according to an embodiment of the disclosure;

FIG. 8B illustrates an example of shapes of a first electrode and a second electrode according to an embodiment of the disclosure;

FIG. 8C illustrates an example of shapes of a first electrode and a second electrode according to an embodiment of the disclosure;

FIG. 9A illustrates an example in which a first electrode and a second electrode are disposed in an electronic device according to an embodiment of the disclosure;

FIG. 9B illustrates an example in which a first electrode and a second electrode are disposed in an electronic device according to an embodiment of the disclosure;

FIG. 9C illustrates an example in which a first electrode and a second electrode are disposed in an electronic device according to an embodiment of the disclosure;

FIG. 9D illustrates an example in which a first electrode and a second electrode are disposed in an electronic device according to an embodiment of the disclosure;

FIG. 10A illustrates an example of a block diagram of an electronic device according to an embodiment of the disclosure;

FIG. 10B illustrates an example of a block diagram of an electronic device according to an embodiment of the disclosure;

FIG. 11 illustrates a flowchart of an operation of an electronic device according to an embodiment of the disclosure;

FIG. 12 illustrates a flowchart of an operation of an electronic device according to an embodiment of the disclosure;

FIG. 13A illustrates a change in a first capacitance value and a second capacitance value in a case that a tap input is generated, according to an embodiment of the disclosure;

FIG. 13B illustrates a change in a first capacitance value and a second capacitance value in a case that a double tap input is generated, according to an embodiment of the disclosure;

FIG. 14 illustrates a flowchart of an operation of an electronic device according to an embodiment of the disclosure;

FIG. 15A illustrates a change in a first capacitance value and a second capacitance value in a case that a tap input is generated, according to an embodiment of the disclosure;

FIG. 15B illustrates a change in a first capacitance value and a second capacitance value in a case that a double tap input is generated, according to an embodiment of the disclosure;

FIG. 16 illustrates an example of an operation of an electronic device according to an embodiment of the disclosure; and

FIG. 17 illustrates an example of an operation of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

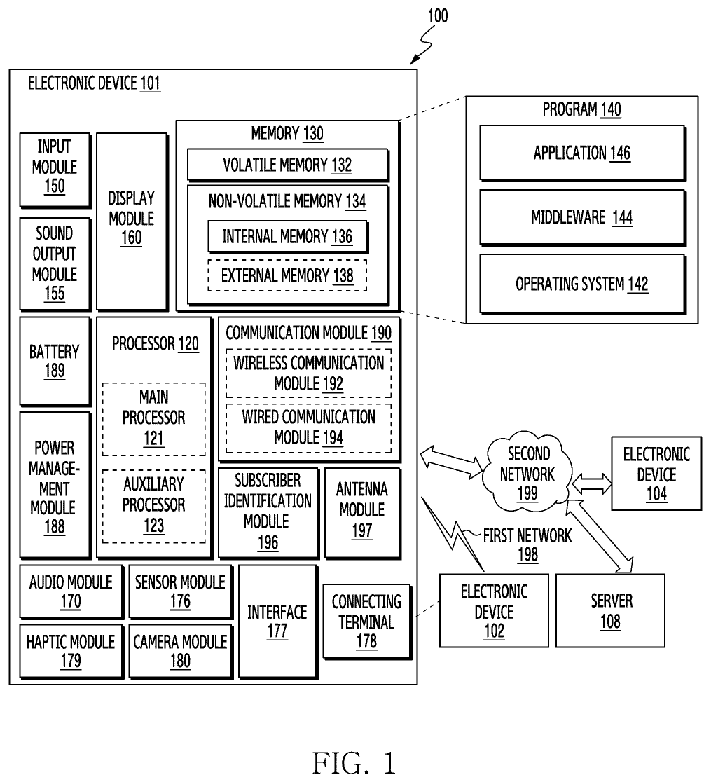

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101.

The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment, an electronic device (e.g., the electronic device 101 of FIG. 1) described below may include touch sensor circuitry connected to a first electrode and a second electrode. The electronic device may identify an approach of an external object, by using the touch sensor circuitry. The electronic device may identify whether the external object corresponds to a part of a body of a user, by using the touch sensor circuitry. The electronic device may identify a touch input based on the external object corresponding to the part of the body of the user. In addition, the electronic device may identify that the external object is not the part of the body of the user. For example, the electronic device may identify the external object as a foreign substance including moisture (e.g., water) (or a foreign substance causing a change in capacitance). In the following specification, a structure of the first electrode and the second electrode configured to perform the above-described operation and an example of an operation of the touch sensor circuitry may be described.

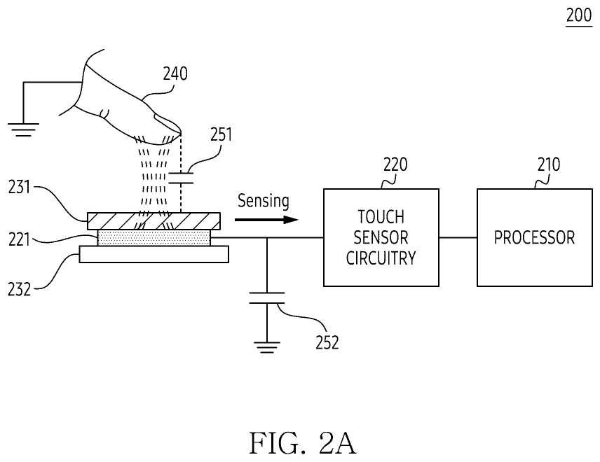

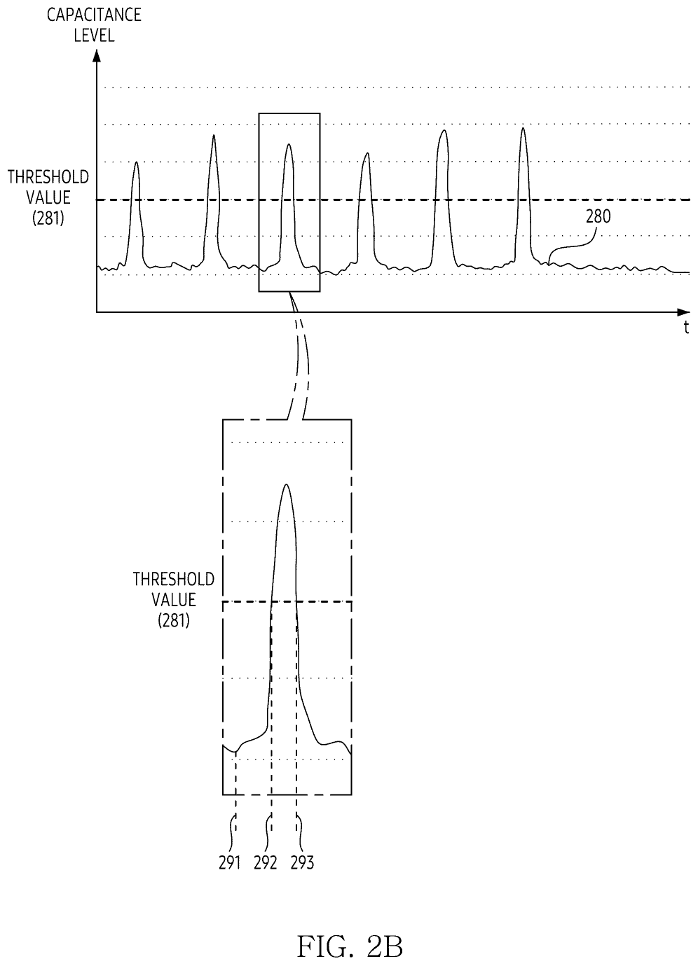

FIG. 2A illustrates an example of touch sensor circuitry connected to one electrode according to an embodiment of the disclosure.

FIG. 2B illustrates an example of a change in capacitance magnitude for identifying a touch input according to an embodiment of the disclosure.

According to various embodiments, an electronic device 200 of FIGS. 2A and 2B may be at least partially similar to the electronic device 101 of FIG. 1, or may include other embodiments of the electronic device.

Referring to FIG. 2A, the electronic device 200 may include a structure for identifying a touch input using a single electrode. The electronic device 200 may identify capacitance using the single electrode. The electronic device 200 may identify the touch input based on the capacitance (or a change in capacitance). A state (or the structure) for identifying the touch input using the single electrode may be referred to as a self capacitance system. For example, in a case that the electronic device 200 includes a structure for identifying the touch input using the single electrode, the electronic device 200 may identify a touch input in an area for the single electrode.

According to an embodiment, the electronic device 200 may include a processor 210 (e.g., the processor 120 of FIG. 1), touch sensor circuitry 220, an electrode 221, an overlay 231, and a substrate 232. For example, the overlay 231 may refer to a structure positioned between the electrode 221 and an external object 240. As an example, the overlay 231 may include a substrate or a housing. Referring to FIG. 2A, the overlay 231 is illustrated as being in contact with the electrode 221, but is not limited thereto. The overlay 231 may be spaced apart from the electrode 221. For example, the electrode 221 may be disposed on the substrate 232.

For example, the electrode 221 may be connected to the touch sensor circuitry 220. The touch sensor circuitry 220 may be connected to the processor 210. The processor 210 may be set to control the touch sensor circuitry 220. The processor 210 may identify whether a touch input by the external object 240 is generated through the touch sensor circuitry 220. For example, the external object 240 may mean a part (e.g., a finger) of a body of a user.

According to an embodiment, the external object 240 and the electrode 221 may each function as one parallel plate forming a capacitor. A space between the external object 240 and the electrode 221 may operate as one self equivalent capacitor 251. Capacitance CH of the self equivalent capacitor 251 may be set as in the following equation.

$${C}_{H} = ε \times \frac{A}{D} \qquad Equation 1$$

Equation 1 above is merely an example for helping understanding, but is not limited thereto, and may be modified, applied, or extended in various ways.

Referring to Equation 1, CH is the capacitance of the self equivalent capacitor 251 between the external object 240 and the electrode 221. Epsilon (ε) is permittivity between the external object 240 and the electrode 221. d is a distance between the external object 240 and the electrode 221. A is an area of the external object 240 and the electrode 221 for configuring an electric field. As in Equation 1, as the distance between the external object 240 and the electrode 221 becomes closer, magnitude of the capacitance CH of the self equivalent capacitor 251 may increase.

For example, at least one component (e.g., wiring or a peripheral element) may be included between the touch sensor circuitry 220 and the electrode 221. A parasitic capacitance Cₚ may be generated by the at least one component between the touch sensor circuitry 220 and the electrode 221. The parasitic capacitance Cₚ may be represented in circuitry of the electronic device 200 as a parasitic equivalent capacitor 252. Although the parasitic equivalent capacitor 252 is illustrated in FIG. 2A, the parasitic equivalent capacitor 252 is only an equivalent model and may not be an actual component.

For example, the self equivalent capacitor 251 and the parasitic equivalent capacitor 252 may be connected in parallel. The processor 210 may identify capacitance C_{d} for the self equivalent capacitor 251 and the parasitic equivalent capacitor 252 connected in parallel, by using the touch sensor circuitry 220. The capacitance C_{d} for the self equivalent capacitor 251 and the parasitic equivalent capacitor 252 connected in parallel may be configured as in Equation 2.

$${C}_{d} = {C}_{H} + {C}_{p} \qquad Equation 2$$

Equation 2 above is merely an example for helping understanding, but is not limited thereto, and may be modified, applied, or extended in various ways.

Referring to Equation 2, C_{d} is the capacitance for the self equivalent capacitor 251 and the parasitic equivalent capacitor 252 connected in parallel. C_{H} is the capacitance for the self equivalent capacitor 251. Cₚ is the capacitance for the parasitic equivalent capacitor 252.

According to an embodiment, as the distance between the external object 240 and the electrode 221 becomes closer, the capacitance C_{H} for the self equivalent capacitor 251 may increase. Accordingly, the capacitance C_{d} identified through the touch sensor circuitry 220 may increase as the distance between the external object 240 and the electrode 221 becomes closer. An example of a graph indicating a change in the capacitance C_{d} identified through the touch sensor circuitry 220 will be described in FIG. 2B.

Referring to FIG. 2B, a graph 280 indicates a capacitance level over time identified through the touch sensor circuitry 220 in a case that the part (e.g., a finger) of the body of the user is repeatedly touched in an area corresponding to the electrode 221. The part of the body of the user may be an example of the external object 240 of FIG. 2A.

At a timing 291, the part of the body of the user may approach the electrode 221. For example, the part of the body of the user may approach the area corresponding to the electrode 221. The area may correspond to at least a portion of a surface of the overlay 231.

As the part of the body of the user approaches the electrode 221, magnitude of capacitance identified through the touch sensor circuitry 220 may increase. For example, the processor 210 may set a threshold value 281 for identifying a touch input based on the magnitude of the capacitance.

According to an embodiment, the processor 210 may identify that the touch input has been received based on identifying that the magnitude of the capacitance is greater than the threshold value 281. For example, the processor 210 may identify that the touch input has been received based on identifying that the magnitude of the capacitance is greater than the threshold value 281 at a timing 292. The processor 210 may identify that the touch has been released based on identifying that the magnitude of the capacitance is reduced to less than or equal to the threshold value 281 at a timing 293.

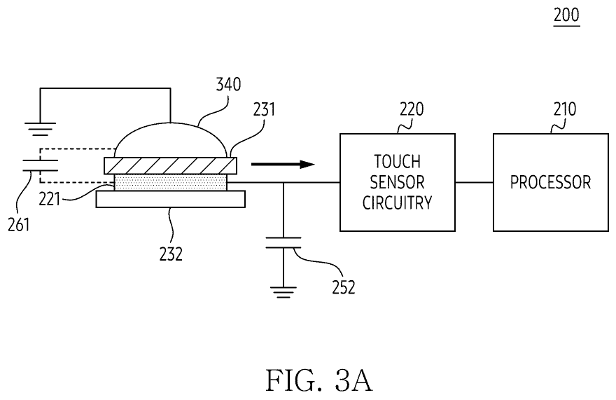

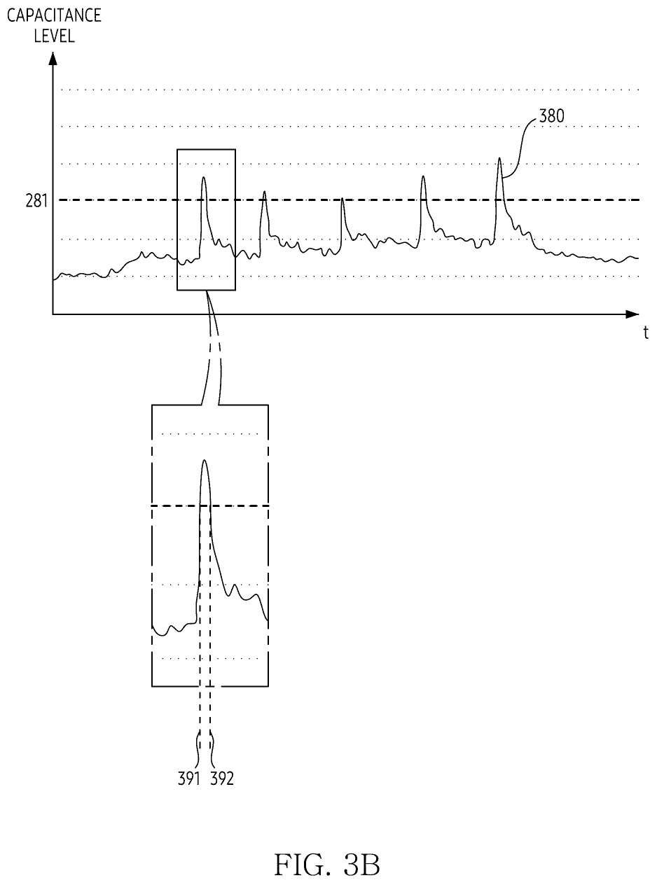

In FIGS. 2A and 2B, in a case that the external object 240 approaches the electronic device 200, an example of an operation of the electronic device 200 has been described. In a case that a foreign substance including moisture is positioned on a surface of the overlay 231, an example of an operation of the electronic device 200 will be described in FIGS. 3A and 3B.

FIG. 3A illustrates an example of touch sensor circuitry connected to one electrode according to an embodiment of the disclosure.

FIG. 3B illustrates an example of a change in capacitance magnitude for identifying a touch input according to an embodiment of the disclosure.

Referring to FIG. 3A, an electronic device 200 may include a processor 210, touch sensor circuitry 220, an electrode 221, an overlay 231, and a substrate 232. The electronic device 200 illustrated in FIG. 3A may correspond to the electronic device 200 of FIG. 2A.

According to an embodiment, a foreign substance 340 including moisture (or a foreign substance causing a change in capacitance) may be positioned on a surface of the overlay 231. For example, water may adhere to the surface of the overlay 231.

For example, the electrode 221 and the foreign substance 340 including moisture may each function as a parallel plate of capacitor. A space between the foreign substance 340 and the electrode 221 may operate as one self equivalent capacitor 261. In addition, magnitude of capacitance of the self equivalent capacitor 261 may increase as the foreign substance 340 is positioned on the surface of the overlay 231. Accordingly, capacitance C_{d} identified through the touch sensor circuitry 220 may also increase. An example of a graph indicating a change in the capacitance C_{d} identified through the touch sensor circuitry 220 according to whether the foreign substance 340 is positioned on the surface of the overlay 231 will be described in FIG. 3B.

Referring to FIG. 3B, a graph 380 indicates a change in capacitance magnitude over time identified through the touch sensor circuitry 220 in a case that the foreign substance 340 including moisture is positioned in an area corresponding to the electrode 221 (e.g., at least a portion of the surface of the overlay 231).

At a timing 391, as the foreign substance 340 is positioned in the area corresponding to the electrode 221, the magnitude of the capacitance may be greater than a threshold value 281. The processor 210 may identify that a touch input has been received based on identifying that the magnitude of the capacitance is greater than the threshold value 281. The processor 210 may identify a touch input caused by the foreign substance 340 including moisture, which is not a part of a body of a user.

At a timing 392, as the foreign substance 340 is removed from the area corresponding to the electrode 221, the magnitude of the capacitance may be reduced to less than or equal to the threshold value 281. The processor 210 may identify that the touch input has been released based on identifying that the magnitude of the capacitance is less than or equal to the threshold value 281.

As in the above-described embodiment, the processor 210 may identify an input by the foreign substance 340 as a touch input based on moisture being positioned in the area corresponding to the electrode 221.

Referring to FIGS. 2A, 2B, 3A, and 3B, the processor 210 may identify that the touch input is received based on identifying that the magnitude of the capacitance identified through the touch sensor circuitry 220 is greater than the threshold value 281.

In a case that a single electrode (e.g., the electrode 221) is used, touch sensitivity may be improved since a sensing area of capacitance is wide. In a case that the single electrode (e.g., the electrode 221) is used, a structure of a system for identifying whether a touch input is generated may be simplified.

However, in a case that the single electrode (e.g., the electrode 221) is used, magnitude of the capacitance may increase as the part of the body of the user approaches the electrode. In addition, as the foreign substance 340 including moisture approaches the electrode, the magnitude of the capacitance may increase. The single electrode may not be able to distinguish the part of the body of the user and the foreign substance 340 including moisture. Accordingly, a malfunction in which a touch input is identified by the foreign substance 340 may be generated.

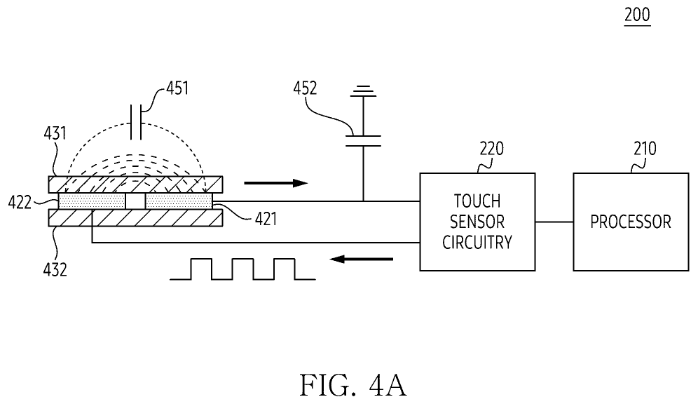

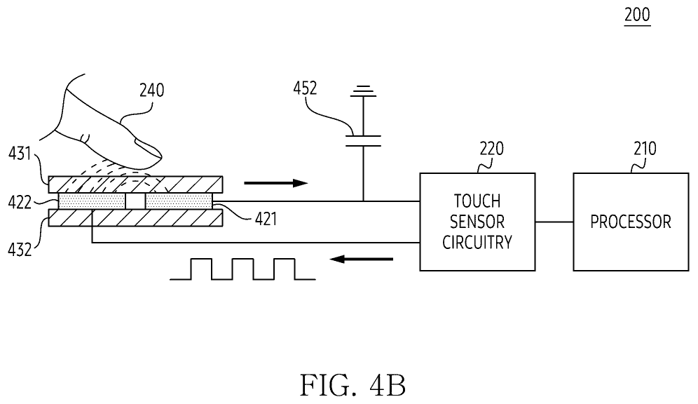

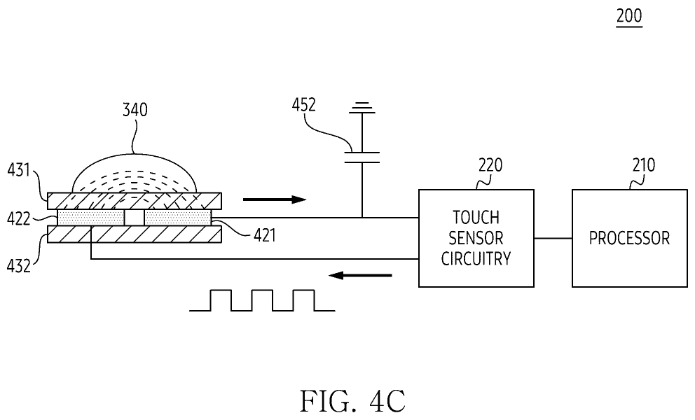

FIG. 4A illustrates an example of touch sensor circuitry connected to a plurality of electrodes according to an embodiment of the disclosure.

FIG. 4B illustrates an example of an operation of touch sensor circuitry connected to a plurality of electrodes according to an embodiment of the disclosure.

FIG. 4C illustrates an example of an operation of touch sensor circuitry connected to a plurality of electrodes according to an embodiment of the disclosure.

Referring to FIG. 4A, an electronic device 200 may include a structure for identifying a touch input using a plurality of electrodes (e.g., a first electrode 421 and a second electrode 422). The electronic device 200 may identify capacitances using a plurality of electrodes. The electronic device 200 may identify the touch input based on the capacitances (or a change in capacitances). A state (or the structure) for identifying the touch input using the plurality of electrodes may be referred to as a mutual capacitance system. For example, in a case that the electronic device 200 includes the structure for identifying the touch input using the plurality of electrodes, the electronic device 200 may identify a touch input in an area corresponding to the plurality of electrodes.

According to an embodiment, the electronic device 200 may include a processor 210, touch sensor circuitry 220, the first electrode 421, the second electrode 422, an overlay 431, and a substrate 432.

For example, the overlay 431 may mean a structure positioned between an external environment and the first electrode 421 (or the second electrode 422). In FIG. 4A, the overlay 431 is illustrated as being in contact with the first electrode 421 and the second electrode 422, but is not limited thereto. The overlay 431 may be in a state of being spaced apart from the first electrode 421 and the second electrode 422.

For example, the first electrode 421 and the second electrode 422 may be disposed on the substrate 432. The first electrode 421 and the second electrode 422 may be disposed on a surface of the substrate 432. Although FIG. 4A illustrates that the first electrode 421 and the second electrode 422 are disposed on one substrate 432, it is not limited thereto. The first electrode 421 and the second electrode 422 may be disposed on different substrates, respectively. For example, the first electrode 421 and the second electrode 422 may be spaced apart from each other.

For example, the first electrode 421 and the second electrode 422 may be connected to the touch sensor circuitry 220. The touch sensor circuitry 220 may be connected to the processor 210. The processor 210 may be set to control the touch sensor circuitry 220. The processor 210 may identify whether a touch input by an external object 240 is generated through the touch sensor circuitry 220. For example, the external object 240 may mean a part (e.g., a finger) of a body of a user.

According to an embodiment, a voltage may be applied to the second electrode 422. The processor 210 may apply the voltage to the second electrode 422 using the touch sensor circuitry 220. For example, the processor 210 may apply a pulse voltage (e.g., a square wave) to the second electrode 422. A coupling may be generated between the first electrode 421 and the second electrode 422 based on the applied voltage. As the coupling is generated, capacitance CM between the first electrode 421 and the second electrode 422 may be formed. As the coupling is generated, an electric field may be formed between the first electrode 421 and the second electrode 422. For example, the capacitance Cm between the first electrode 421 and the second electrode 422 may be referred to as mutual capacitance. For example, the first electrode 421 and the second electrode 422 may each function as one parallel plate forming a capacitor. The first electrode 421 and the second electrode 422 may operate as one self equivalent capacitor 451.

For example, parasitic capacitance Cₚ may be generated by at least one component (e.g., wiring or a peripheral element) between the touch sensor circuitry 220 and the first electrode 421, and at least one component (e.g., wiring or a peripheral element) between the touch sensor circuitry 220 and the second electrode 422. The parasitic capacitance Cₚ may be represented in circuitry of the electronic device 200 as an equivalent capacitor 452. Although the equivalent capacitor 452 is illustrated in FIG. 4A, the equivalent capacitor 452 is only an equivalent model and may not be an actual component.

For example, by using the touch sensor circuitry 220, the processor 210 may apply the voltage (e.g., the pulse voltage) to the second electrode 422 and identify capacitance between the first electrode 421 and the second electrode 422 through the first electrode 421. As an example, the processor 210 may identify capacitance for the mutual equivalent capacitor 451 and the parasitic equivalent capacitor 452. The processor 210 may identify capacitance (i.e., CM) for the mutual equivalent capacitor 451 based on removing parasitic capacitance (i.e., Cₚ) from the capacitance for the mutual equivalent capacitor 451 and the equivalent capacitor 452. Accordingly, the processor 210 may identify the capacitance (i.e., C_{M}) between the first electrode 421 and the second electrode 422.

According to an embodiment, as a distance between the external object 240 and the overlay 431 (or the first electrode 421 and the second electrode 422) becomes closer, the capacitance between the first electrode 421 and the second electrode 422 may become smaller. On the other hand, as a distance between a foreign substance 340 including moisture and the overlay 431 becomes closer, the capacitance between the first electrode 421 and the second electrode 422 may become larger. Referring to FIG. 4B, in a case that the distance between the external object 240 and the overlay 431 becomes closer, a change in capacitance between the first electrode 421 and the second electrode 422 may be described. Referring to FIG. 4C, in a case that the distance between the foreign substance 340 including moisture and the overlay 431 becomes closer, the change in capacitance between the first electrode 421 and the second electrode 422 may be described.

Referring to FIGS. 4B and 4C, the processor 210 may apply the voltage to the second electrode 422 through the touch sensor circuitry 220. For example, the processor 210 may apply the pulse voltage to the second electrode 422 based on a specified time period through the touch sensor circuitry 220. As an example, the processor 210 may apply the specified voltage to the second electrode 422 based on the specified time period. As the pulse voltage is applied to the second electrode 422, the electric field may be formed between the first electrode 421 and the second electrode 422. The processor 210 may identify the capacitance between the first electrode 421 and the second electrode 422.

For example, the processor 210 may identify the capacitance for the mutual equivalent capacitor 451 and the parasitic equivalent capacitor 452 through the touch sensor circuitry 220. The processor 210 may identify the capacitance for the mutual equivalent capacitor 451 by removing capacitance (i.e., parasitic capacitance) for the parasitic equivalent capacitor 452 from the capacitance for the mutual equivalent capacitor 451 and the parasitic equivalent capacitor 452. Accordingly, the processor 210 may identify the capacitance between the first electrode 421 and the second electrode 422.

Referring to FIG. 4B, the processor 210 may identify whether the external object 240 approaches while the pulse voltage is applied to the second electrode 422 based on the specified time period. For example, the processor 210 may identify whether the external object 240 approaches based on the capacitance (or the change in capacitance) between the first electrode 421 and the second electrode 422. As an example, since the external object 240 is the part of the body of the user, it may have ground. At least a portion of the electric field formed between the first electrode 421 and the second electrode 422 may be transmitted (or absorbed) to the external object 240. As an example, coupling may be generated between the second electrode 422 and the external object 240 (e.g., the finger). Magnitude of the electric field formed between the first electrode 421 and the second electrode 422 may be reduced. As the magnitude of the electric field formed between the first electrode 421 and the second electrode 422 is reduced, the capacitance between the first electrode 421 and the second electrode 422 may decrease. The processor 210 may identify that the external object 240 contacts the overlay 431 (or the electronic device 200) based on identifying that the capacitance between the first electrode 421 and the second electrode 422 is less than or equal to a threshold value. The processor 210 may identify the touch input by the external object 240 based on identifying that the external object 240 contacts the overlay 431 (or the electronic device 200).

After the external object 240 contacts the overlay 431 (or the electronic device 200), as the external object 240 is separated from the overlay 431, the magnitude of the electric field formed between the first electrode 421 and the second electrode 422 may increase. As the magnitude of the electric field formed between the first electrode 421 and the second electrode 422 increases, the capacitance between the first electrode 421 and the second electrode 422 may increase. The processor 210 may identify that the contact of the external object 240 is released based on identifying that the capacitance between the first electrode 421 and the second electrode 422 is greater than the threshold value. The processor 210 may identify that the touch input is released based on identifying that the contact of the external object 240 is released.

Referring to FIGS. 2A and 4B, in a case that a single electrode (e.g., the electrode 221 of FIG. 2A) is used, capacitance identified through the touch sensor circuitry 220 may increase as the external object 240 (e.g., the part of the body of the user) approaches. In a case that the plurality of electrodes (e.g., the first electrode 421 and the second electrode 422 of FIG. 4B) are used, the capacitance identified through the touch sensor circuitry 220 may decrease as the external object 240 (e.g., the part of the body of the user) approaches.

Referring to FIG. 4C, the processor 210 may identify whether the foreign substance 340 including moisture contacts (or is positioned in) a surface of the overlay 431 while the pulse voltage is applied to the second electrode 422 based on the specified time period. For example, based on the capacitance (or the change in capacitance) between the first electrode 421 and the second electrode 422, the processor 210 may identify whether the foreign substance 340 contacts (or is positioned).

For example, the electric field may be formed between the first electrode 421 and the second electrode 422 while the pulse voltage is applied to the second electrode 422 based on the specified time period. Each of the first electrode 421 and the second electrode 422 may function as a parallel plate of a capacitor. The foreign substance 340 including moisture may be positioned in a path of the electric field formed between the first electrode 421 and the second electrode 422. The foreign substance 340 may function as a dielectric between parallel plates of a capacitor. Since moisture has higher permittivity than air (e.g., approximately 80 times), the capacitance between the first electrode 421 and the second electrode 422 may increase. As an example, based on the foreign substance 340 including moisture contacting the surface of the overlay 431, an anti-capacitance phenomenon in which the capacitance between the first electrode 421 and the second electrode 422 increases may occur.

Referring to FIGS. 4B and 4C, in a case that the plurality of electrodes (e.g., the first electrode 421 and the second electrode 422 of FIG. 4B) are used, the capacitance identified through the touch sensor circuitry 220 may decrease as the external object 240 (e.g., the part of the body of the user) approaches. In a case that the plurality of electrodes (e.g., the first electrode 421 and the second electrode 422 of FIG. 4B) are used, the capacitance identified through the touch sensor circuitry 220 may increase according to the contact of the foreign substance 340 including moisture (e.g., water or rain).

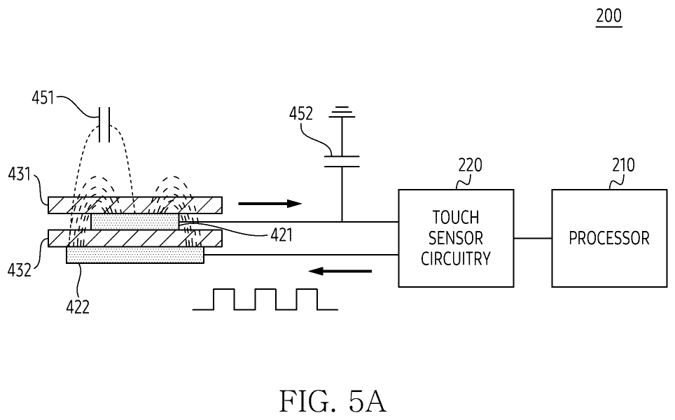

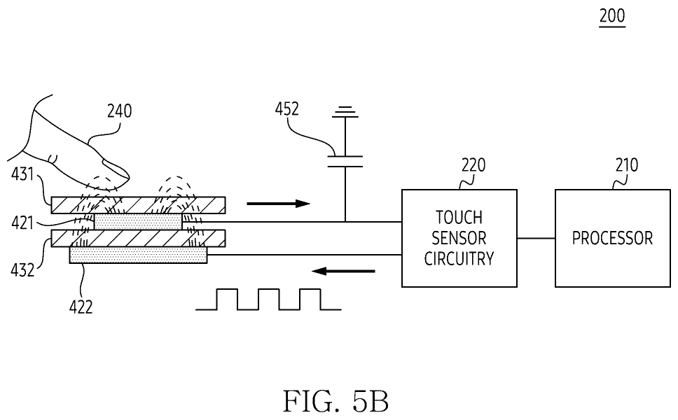

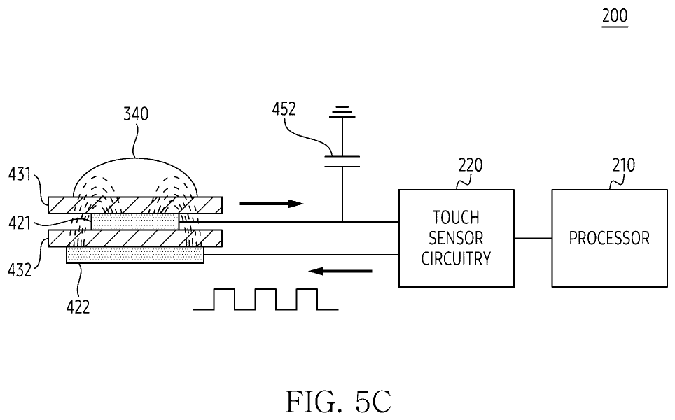

FIG. 5A illustrates an example of touch sensor circuitry connected to a plurality of electrodes according to an embodiment of the disclosure.

FIG. 5B illustrates an example of an operation of touch sensor circuitry connected to a plurality of electrodes according to an embodiment of the disclosure.

FIG. 5C illustrates an example of an operation of touch sensor circuitry connected to a plurality of electrodes according to an embodiment of the disclosure.

Referring to FIG. 5A, an electronic device 200 may include a structure for identifying a touch input using a plurality of electrodes (e.g., a first electrode 421 and a second electrode 422). The electronic device 200 may identify capacitances using the plurality of electrodes. The electronic device 200 may identify the touch input based on the capacitances (or a change in capacitances). A state (or structure) for identifying the touch input using the plurality of electrodes may be referred to as a mutual capacitance system. For example, in a case that the electronic device 200 includes the structure for identifying the touch input using the plurality of electrodes, the electronic device 200 may identify a touch input in an area corresponding to the plurality of electrodes.

According to an embodiment, the electronic device 200 may include a processor 210, touch sensor circuitry 220, the first electrode 421, the second electrode 422, an overlay 431, and a substrate 432.

For example, the overlay 431 may mean a structure positioned between an external environment and the first electrode 421. In FIG. 5A, the overlay 431 is illustrated as being in contact with the first electrode 421, but is not limited thereto. The overlay 431 may be in a state of being spaced apart from the first electrode 421.

For example, the first electrode 421 may be disposed on a first surface of the substrate 432. The first electrode 421 may be disposed on a first area having a first size in the first surface. A size of a surface of the first electrode 421 having a direction toward the first surface may be set to the first size. The second electrode 422 may be disposed on a second surface opposite to the first surface of the substrate 432. The second electrode 422 may be disposed on a second area having a second size larger than the first size in the second surface. A size of a surface of the second electrode 422 having a direction toward the second surface may be set to the second size.

For example, the first area in which the first electrode 421 is disposed may correspond to the second area in which the second electrode 422 is disposed. As an example, the first area may face the second area with the substrate 432 interposed therebetween.

In FIG. 5A, the second electrode 422 is illustrated as being disposed on the second surface of the substrate 432, but is not limited thereto. The second electrode 422 may be spaced apart from the substrate 432. For example, the second electrode 422 may be disposed on another substrate distinguished from the substrate 432.

According to an embodiment, functions of each of the processor 210, the touch sensor circuitry 220, the first electrode 421, the second electrode 422, the overlay 431, and the substrate 432 may correspond to functions of each of the processor 210, the touch sensor circuitry 220, the first electrode 421, the second electrode 422, the overlay 431, and the substrate 432 illustrated in FIG. 4A.

For example, a voltage may be applied to the second electrode 422. The processor 210 may apply the voltage to the second electrode 422 using the touch sensor circuitry 220. Based on the voltage being applied to the second electrode 422, capacitance C_{M} may be formed between the first electrode 421 and the second electrode 422. A space between the first electrode 421 and the second electrode 422 may operate as one mutual equivalent capacitor 451.

As an example, an electric field may be formed from a surface of the second electrode 422 facing the first electrode 421 to a surface of the first electrode 421 facing the overlay 431. The capacitance Cy between the first electrode 421 and the second electrode 422 may be formed based on the formed electric field.

For example, parasitic capacitance Cₚ may be generated by at least one component (e.g., wiring or a peripheral element) between the touch sensor circuitry 220 and the first electrode 421, and at least one component (e.g., wiring or a peripheral element) between the touch sensor circuitry 220 and the second electrode 422. The parasitic capacitance Cₚ may be represented in circuitry of the electronic device 200 as a parasitic equivalent capacitor 452. Although the parasitic equivalent capacitor 452 is illustrated in FIG. 5A, the parasitic equivalent capacitor 452 is only an equivalent model and may not be an actual component.

For example, by using the touch sensor circuitry 220, the processor 210 may apply the voltage (e.g., the pulse voltage) to the second electrode 422 and identify capacitance between the first electrode 421 and the second electrode 422 through the first electrode 421. As an example, the processor 210 may identify capacitance for the mutual equivalent capacitor 451 and the parasitic equivalent capacitor 452. The processor 210 may identify capacitance (i.e., C_{M}) for the mutual equivalent capacitor 451 based on removing parasitic capacitance (i.e., Cₚ) from the capacitance for the mutual equivalent capacitor 451 and the parasitic equivalent capacitor 452. Accordingly, the processor 210 may identify the capacitance (i.e., C_{M}) between the first electrode 421 and the second electrode 422.

According to an embodiment, as a distance between the external object 240 and the overlay 431 (or the first electrode 421) becomes closer, the capacitance between the first electrode 421 and the second electrode 422 may become smaller. On the other hand, as a distance between a foreign substance 340 including moisture and the overlay 431 becomes closer, the capacitance between the first electrode 421 and the second electrode 422 may become larger. In FIG. 5B, in a case that the distance between the external object 240 and the overlay 431 becomes closer, a change in capacitance between the first electrode 421 and the second electrode 422 may be described. In FIG. 5C, in a case that the distance between the foreign substance 340 including moisture and the overlay 431 becomes closer, the change in capacitance between the first electrode 421 and the second electrode 422 may be described.

Referring to FIG. 5B, the capacitance between the first electrode 421 and the second electrode 422 may be reduced based on approach of the external object 240. The processor 210 may identify whether the external object 240 contacts the overlay 431 (or the electronic device 200) based on the change in capacitance between the first electrode 421 and the second electrode 422. An operation of identifying whether the external object 240 contacts the overlay 431 (or the electronic device 200) may correspond to the operation described in FIG. 4B.

According to an embodiment, as illustrated in FIG. 2A, by using the first electrode 421, the processor 210 may identify a touch input using a single electrode. For example, the processor 210 may identify a touch input using the plurality of electrodes (e.g., the first electrode 421 and the second electrode 422).

Unlike FIG. 5B, according to the structure of FIG. 4B, an area in which the touch input is identified using the single electrode (e.g., the first electrode 421) may be distinguished from an area in which the touch input is identified using the plurality of electrodes (e.g., the first electrode 421 and the second electrode 422). On the other hand, according to the structure of FIG. 5B, the area in which the touch input is identified using the single electrode (e.g., the first electrode 421) may correspond to the area in which the touch input is identified using the plurality of electrodes (e.g., first electrode 421 and second electrode 422). Accordingly, the processor 210 may identify the touch input on the same or similar area using at least one of the single electrode and the plurality of electrodes.

Referring to FIG. 5C, the processor 210 may identify whether the foreign substance 340 including moisture contacts (or is positioned in) a surface of the overlay 431 while the pulse voltage is applied to the second electrode 422 based on the specified time period. For example, based on the capacitance (or the change in capacitance) between the first electrode 421 and the second electrode 422, the processor 210 may identify whether the foreign substance 340 contacts (or is positioned). An operation of identifying whether the foreign substance 340 contacts (or is positioned) may correspond to the operation described in FIG. 4C.

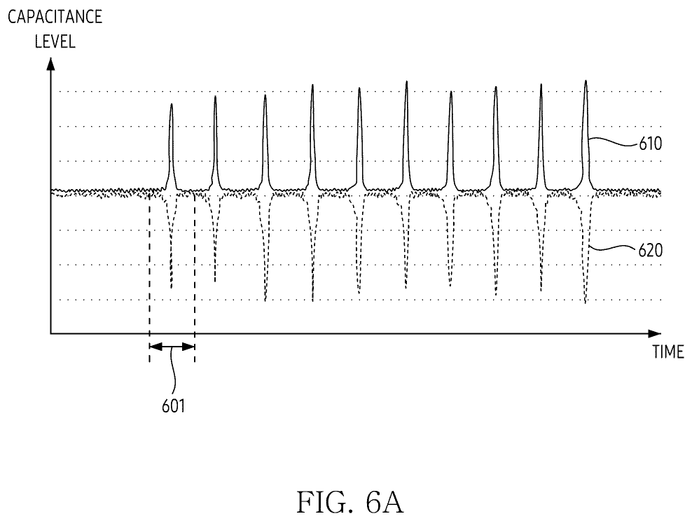

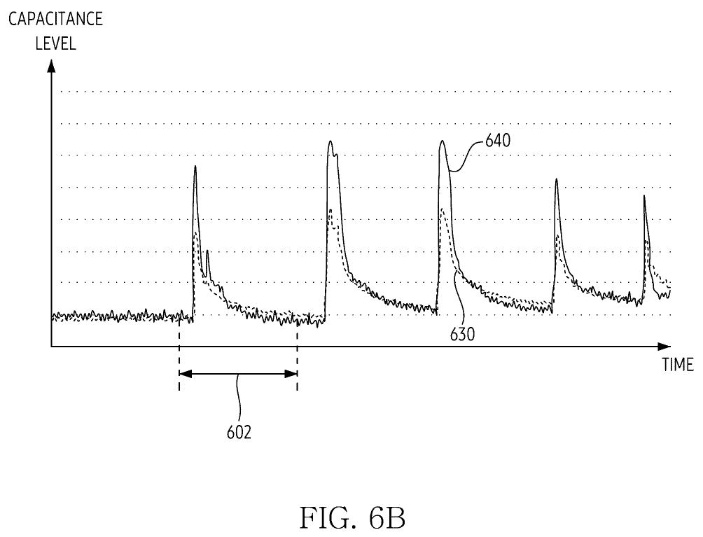

FIG. 6A illustrates an example of first capacitance and second capacitance for identifying a touch input according to an embodiment of the disclosure.

FIG. 6B illustrates an example of first capacitance and second capacitance for identifying a touch input according to an embodiment of the disclosure.

Graphs illustrated in FIGS. 6A and 6B indicate a change in capacitance over time in a case that a first electrode 421 and a second electrode 422 are configured as in FIG. 5A. For example, FIGS. 6A and 6B indicate an example of a change in capacitance in a case that positions of the first electrode 421 and the second electrode 422 are configured as in FIG. 5A, but are not limited thereto. The first electrode 421 and the second electrode 422 may be formed as in FIG. 4B. Start points of a graph 610 and a graph 620 are set to be similar to each other, but this is for convenience of explanation and is not limited thereto. Start points of a graph 630 and a graph 640 are set to be similar to each other, but this is for convenience of explanation and is not limited thereto.

Referring to FIG. 6A, during a time interval illustrated in FIG. 6A, an external object 240 may repeatedly (e.g., 10 times) approach the first electrode 421 and may move away from the first electrode 421. The graph 610 indicates a change in first capacitance over time. The first capacitance may be capacitance identified through a single electrode (e.g., the first electrode 421) according to a change in a position of the external object 240. The graph 620 indicates a change in second capacitance over time. The second capacitance may be capacitance identified through a plurality of electrodes (e.g., the first electrode 421 and the second electrode 422) according to the change in the position of the external object 240. As an example, the second capacitance may mean capacitance between the first electrode 421 and the second electrode 422.

For example, within a time interval 601, the external object 240 may approach an overlay 431 (or the first electrode 421). Based on the approach of the external object 240, the first capacitance may increase. Based on the approach of the external object 240, the second capacitance may decrease. A processor 210 may identify a touch input by the external object 240 based on the first capacitance and the second capacitance. For example, the processor 210 may identify the touch input by the external object 240 based on the first capacitance being greater than a first threshold value and the second capacitance being less than a second threshold value.

Referring to FIG. 6B, during a time interval illustrated in FIG. 6B, a foreign substance 340 including moisture may be repeatedly (e.g., 5 times) positioned on the overlay 431, and the foreign substance 340 may fall from the overlay 431. The graph 630 indicates a change in the first capacitance over time. The first capacitance may be capacitance identified through the single electrode (e.g., the first electrode 421) according to a change in a position of the foreign substance 340. The graph 620 indicates the change in the second capacitance over time. The second capacitance may be capacitance identified through the plurality of electrodes (e.g., the first electrode 421 and the second electrode 422) according to the change in the position of the foreign substance 340. As an example, the second capacitance may mean the capacitance between the first electrode 421 and the second electrode 422.

For example, within a time interval 602, the foreign substance 340 may be positioned on the overlay 431 (or the first electrode 421). Based on the foreign substance 340 being positioned on the overlay 431, the first capacitance may increase. As an example, the first capacitance may increase as water falls on the overlay 431. Based on the foreign substance 340 being positioned on the overlay 431, the second capacitance may increase.

Referring to FIGS. 6A and 6B, as the external object 240 (e.g., a part of a body of a user) contacts on the overlay 431, the first capacitance may increase and the second capacitance may decrease. On the other hand, as the foreign substance 340 including moisture is positioned on the overlay 431, both the first capacitance and the second capacitance may increase. The processor 210 may distinguish the external object 240 (e.g., the part of the body of the user) and the foreign substance 340 including moisture based on a change in the first capacitance and the second capacitance.

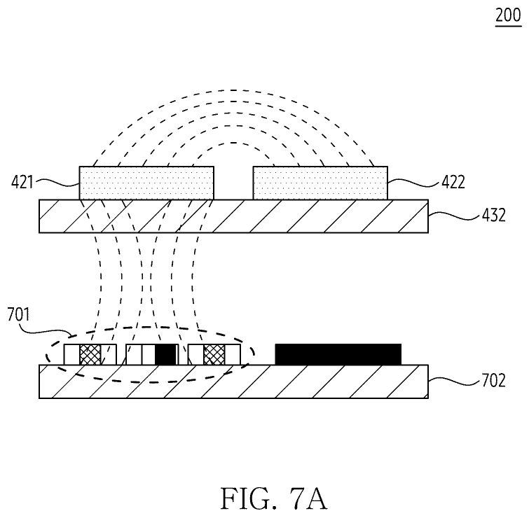

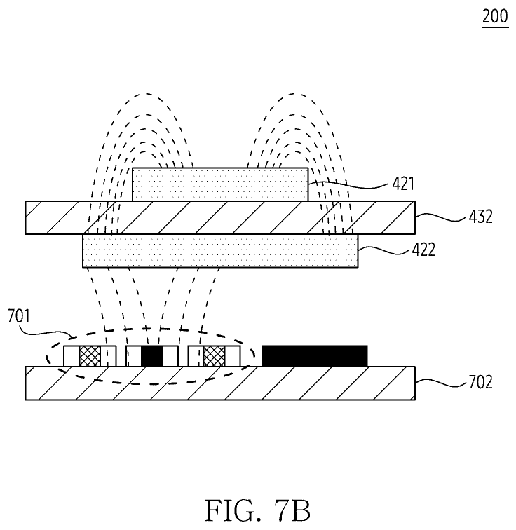

FIG. 7A illustrates an example of interference by at least one component according to an embodiment of the disclosure.

FIG. 7B illustrates an example of interference by at least one component according to an embodiment of the disclosure.

Referring to FIG. 7A, a first electrode 421 and a second electrode 422 may be disposed on a first surface of a substrate 432. The first electrode 421 and the second electrode 422 may be disposed spaced apart from each other on the first surface. A substrate 702 may be disposed in a direction toward a second surface opposite to the first surface of the substrate 432. At least one component 701 may be disposed on the substrate 702. The at least one component 701 may be faced away from the second surface. An electromagnetic wave may be generated according to an operation of the at least one component 701. The electromagnetic wave may affect the first electrode 421. Therefore, the electromagnetic wave generated from the at least one component 701 may affect first capacitance identified through the first electrode 421 and second capacitance identified through the first electrode 421 and the second electrode 422.

Referring to FIG. 7B, the first electrode 421 may be disposed on the first surface of the substrate 432. For example, the first electrode 421 may be disposed on a first area having a first size in the first surface. The second electrode 422 may be disposed on the second surface opposite to the first surface of the substrate 432. For example, the second electrode 422 may be disposed on a second area having a second size in the second surface. The second size may be larger than the first size. The second area may correspond to the first area. The second area may be opposite to the first area. When the first electrode 421 and the second electrode 422 are viewed in the direction toward the second surface, the second area may include the first area.

For example, the substrate 702 may be disposed in the direction toward the second surface of the substrate 432. The at least one component 701 may be disposed on the substrate 702. The at least one component 701 may be faced away from the second surface. The electromagnetic wave may be generated according to an operation of the at least one component 701. The electromagnetic wave may be emitted from the at least one component 701 toward the substrate 432.

The at least one component 701 and the second electrode 422 may be coupled. The electromagnetic wave may be emitted from the at least one component 701 toward the second electrode 422. The electromagnetic wave emitted from the at least one component 701 may not affect the first electrode 421. The second electrode 422 may be configured to shield at least a portion of an electromagnetic wave emitted toward the substrate 432. Therefore, the electromagnetic wave generated from the at least one component 701 may not affect the first capacitance identified through the first electrode 421 and the second capacitance identified through the first electrode 421 and the second electrode 422.

As in FIG. 7B, in a case that the first electrode 421 and the second electrode 422 are configured on opposite surfaces of the substrate 432, the electromagnetic wave emitted from the at least one component 701 disposed on the substrate 702 distinguished from the substrate 432 related to the first electrode 421 and the second electrode 422 may be shielded. Therefore, at least a portion or all of the electromagnetic wave emitted from the at least one component 701 may be blocked without another shielding means. The electromagnetic wave emitted from the at least one component 701 may not affect the first capacitance and the second capacitance for identifying a touch input.

As in FIG. 7B, in a case that the first electrode 421 and the second electrode 422 are configured on opposite surfaces of the substrate 432, an area in which a touch input is identified using a single electrode (e.g., the first electrode 421) may correspond to an area in which a touch input is identified using a plurality of electrodes (e.g., the first electrode 421 and the second electrode 422). In a case that the touch input is identified using the single electrode (e.g., the first electrode 421), an area corresponding to the first electrode 421 may be set as an area in which the touch input may be identified. In a case that the touch input is identified using the plurality of electrodes (e.g., the first electrode 421 and the second electrode 422), an area corresponding to the second electrode 422 may be set as an area in which the touch input may be identified. Since the area (e.g., the first area described above) corresponding to the first electrode 421 corresponds to the area (e.g., the second area described above) corresponding to the second electrode 422, the touch input may be identified in the same manner, even when a state in which the single electrode is used and a state in which the plurality of electrodes are used are switched.

As described above, in a case that the first electrode 421 and the second electrode 422 are configured on opposite surfaces of the substrate 432, an electromagnetic wave by other components may be shielded, and a touch input area according to the single electrode may correspond to a touch input area according to the plurality of electrodes. In the following specification, a structure and an operation of an electronic device 200 in which the first electrode 421 and the second electrode 422 are configured on opposite surfaces of the substrate 432 may be described. However, it is not limited thereto.

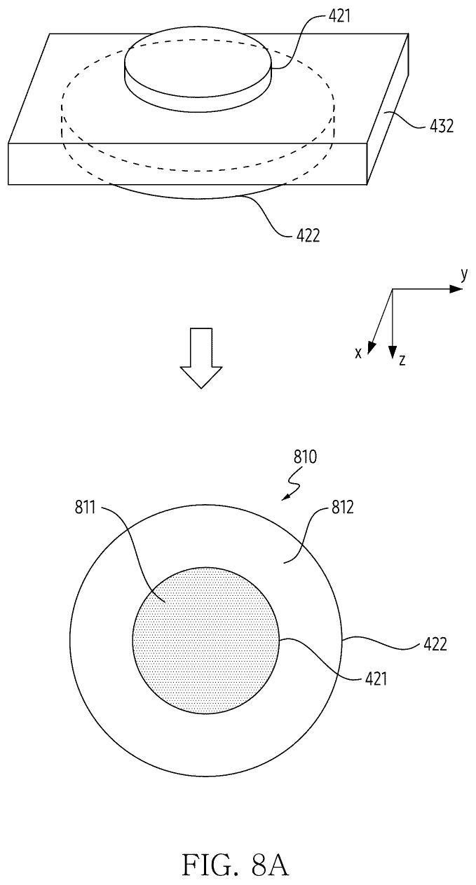

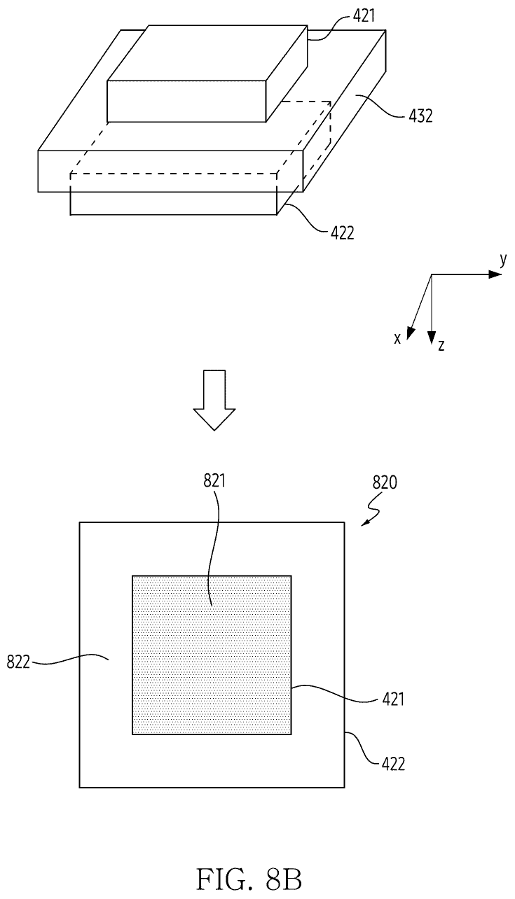

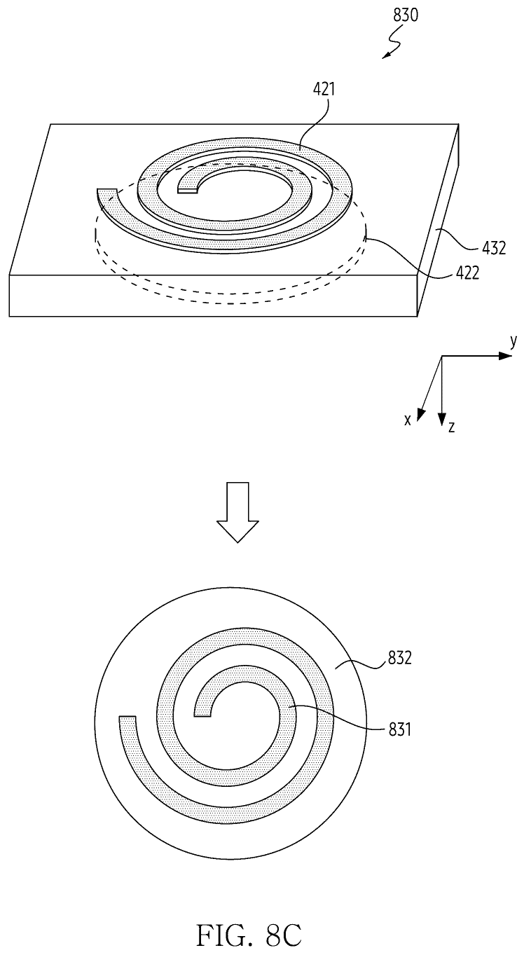

FIG. 8A illustrates an example of shapes of a first electrode and a second electrode according to an embodiment of the disclosure.

FIG. 8B illustrates an example of shapes of a first electrode and a second electrode according to an embodiment of the disclosure.

FIG. 8C illustrates an example of shapes of a first electrode and a second electrode according to an embodiment of the disclosure.

Referring to FIGS. 8A, 8B, and 8C, a first electrode 421 and a second electrode 422 may be disposed on different surfaces of a substrate 432. The first electrode 421 may be disposed on a first surface of the substrate 432. The second electrode 422 may be disposed on a second surface of the substrate 432 opposite to the first surface.

For example, the first electrode 421 may be disposed on a first area having a first size in the first surface. As an example, the first area may be an area that the first electrode 421 occupies on the first surface of the substrate 432. The first area may be configured with the first size.

For example, the second electrode 422 may be disposed on a second area having a second size in the second surface. As an example, the second area may be an area that the second electrode 422 occupies on the second surface of the substrate 432. The second area may be configured with the second size.

For example, when viewed in a direction perpendicular to the first surface or the second surface (e.g., a z direction), the second area may be configured to include the first area.

According to an embodiment, shapes of the first electrode 421 and the second electrode 422 may be configured in various ways. FIGS. 8A to 8C illustrate an example of the shapes of the first electrode 421 and the second electrode 422.

Referring to FIG. 8A, the first electrode 421 and the second electrode 422 may be configured in a form of a circular patch (or a cylinder). When the first electrode 421 and the second electrode 422 are viewed in the z direction, the shapes of the first electrode 421 and the second electrode 422 may be configured as in an example 810. For example, the first electrode 421 may be disposed on a first area 811. The second electrode 422 may be disposed on a second area 812. A size of the first area 811 may be set as the first size. A size of the second area 812 may be set as the second size. The first area 811 may be included in the first surface of the substrate 432. The second area 812 may be included in the second surface of the substrate 432 opposite to the first surface.

Referring to FIG. 8B, the first electrode 421 and the second electrode 422 may be configured in a form of a quadrangle patch (or a quadrangle pillar). When the first electrode 421 and the second electrode 422 are viewed in the z direction, the shapes of the first electrode 421 and the second electrode 422 may be configured as in an example 820. For example, the first electrode 421 may be disposed on a first area 821. The second electrode 422 may be disposed on a second area 822. A size of the first area 821 may be set as the first size. A size of the second area 822 may be set as the second size. The first area 821 may be included in the first surface of the substrate 432. The second area 822 may be included in the second surface of the substrate 432 opposite to the first surface.

Referring to FIG. 8C, the first electrode 421 may be configured in a form of a spiral (e.g., an arithmetical spiral) patch. The second electrode 422 may be configured in a form of a circular patch. When the first electrode 421 and the second electrode 422 are viewed in the z direction, the shapes of the first electrode 421 and the second electrode 422 may be configured as in an example 830. For example, the first electrode 421 may be disposed on a first area 831. The second electrode 422 may be disposed on a second area 832. A size of the first area 831 may be set as the first size.

A size of the second area 832 may be set as the second size. The first area 831 may be included in the first surface of the substrate 432. The second area 832 may be included in the second surface of the substrate 432 opposite to the first surface.

Structures of the first electrode 421 and the second electrode 422 illustrated in FIGS. 8A to 8C are exemplary and are not limited thereto. For example, the first electrode 421 may be configured toward an external environment in which a touch input is generated. The second electrode 422 may be configured toward a direction opposite to the external environment in which the touch input is generated. For example, the size of the second area (e.g., the second size) on the substrate 432 occupied by the second electrode 422 may be larger than the size of the first area (e.g., the first size) on the substrate 432 occupied by the first electrode 421.

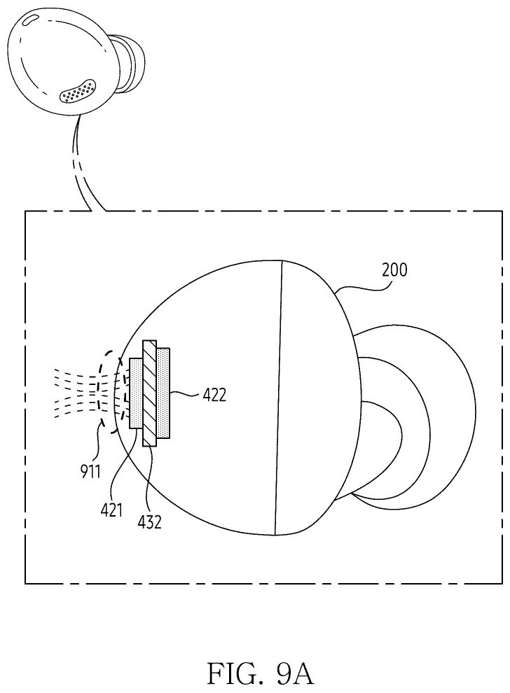

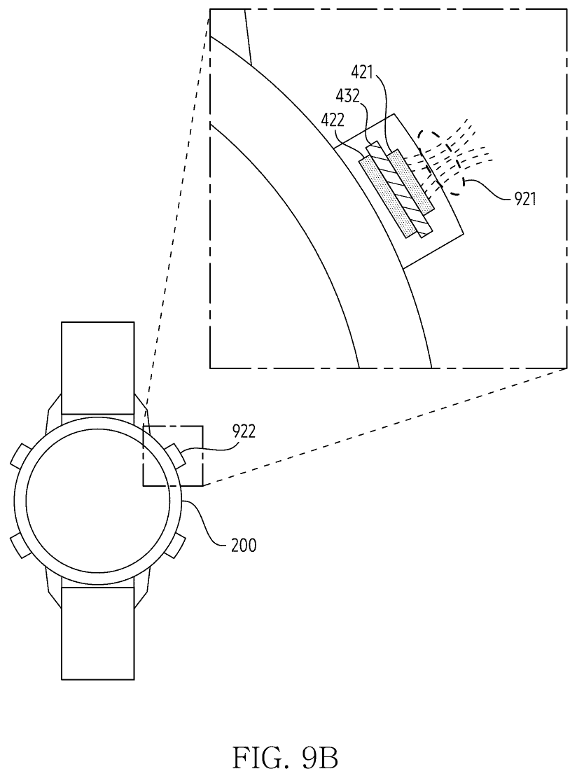

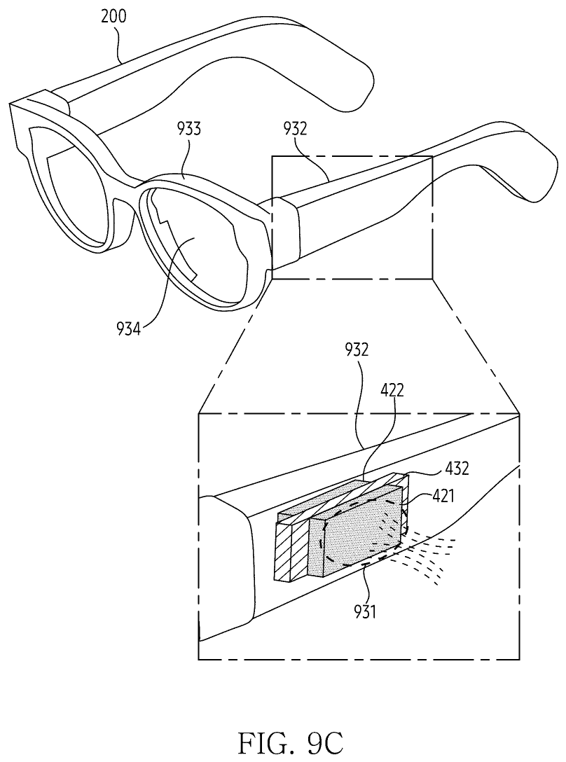

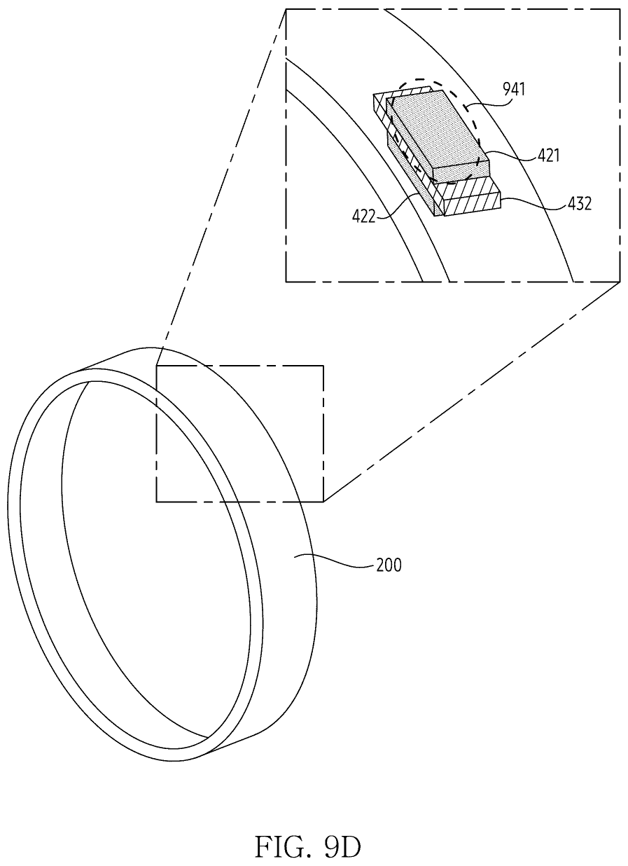

FIG. 9A illustrates an example in which a first electrode and a second electrode are disposed in an electronic device according to an embodiment of the disclosure.

FIG. 9B illustrates an example in which a first electrode and a second electrode are disposed in an electronic device according to an embodiment of the disclosure.

FIG. 9C illustrates an example in which a first electrode and a second electrode are disposed in an electronic device according to an embodiment of the disclosure.

FIG. 9D illustrates an example in which a first electrode and a second electrode are disposed in an electronic device according to an embodiment of the disclosure.

Referring to FIG. 9A, an electronic device 200 may be configured in a form of an earbud. The electronic device 200 may be configured to be worn on another part (e.g., an ear) of a body of a user. A portion of a housing of the electronic device 200 may include an area 911 for receiving a touch input. The electronic device 200 may receive the touch input through a part (e.g., a hand or a finger) of the body of the user in the area 911. The electronic device 200 may identify the part of the body of the user approaching the area 911 (or the electronic device 200). As an example, a processor 210 may identify whether the part of the body of the user approaches the area 911 by using a first electrode 421. The processor 210 may identify whether the touch input of the user is received (or identified) in the area 911 by using the first electrode 421 and a second electrode 422.

For example, the housing of the electronic device 200 may include the first electrode 421, the second electrode 422, and a substrate 432, to provide the area 911 for receiving the touch input. The first electrode 421 may be disposed toward the area 911. The area 911 may correspond to a first area in which the first electrode 421 is disposed on a first surface of the substrate 432.

Referring to FIG. 9B, the electronic device 200 may be configured in a form of a watch. The electronic device 200 may be configured to be worn on another part (e.g., a wrist) of the body of the user. A portion (e.g., a key input device 922) of a housing of the electronic device 200 may include an area 921 for receiving a touch input. The electronic device 200 may receive the touch input through the part (e.g., the hand or the finger) of the body of the user in the area 921. The electronic device 200 may identify the part of the body of the user approaching the area 921 (or the electronic device 200). As an example, the processor 210 may identify whether the part of the body of the user approaches the area 921 by using the first electrode 421. The processor 210 may identify whether the touch input of the user is received (or identified) in the area 911 by using the first electrode 421 and the second electrode 422.

For example, the housing of the electronic device 200 may include the first electrode 421, the second electrode 422, and the substrate 432, to provide the area 921 for receiving the touch input. The first electrode 421 may be disposed toward the area 921. The area 921 may correspond to the first area in which the first electrode 421 is disposed on the first surface of the substrate 432.

FIG. 9B illustrates an example in which the area 921 for receiving the touch input is provided in a surface of the key input device 922 of the electronic device 200, but is not limited thereto. The area 921 may be configured in at least a portion of the electronic device 200. For example, the area 921 may be configured in a portion of a wheel key (not illustrated) configured in the electronic device 200.

Referring to FIG. 9C, the electronic device 200 may be configured in a form of glasses (e.g., an augmented reality (AR) glass). The electronic device 200 may be configured to be worn on another part (e.g., a head) of the body of the user. A portion (e.g., a temple 932) of a housing of the electronic device 200 may include an area 931 for receiving a touch input. The electronic device 200 may receive the touch input through the part (e.g., the hand or the finger) of the body of the user in the area 931. The electronic device 200 may identify the part of the body of the user approaching the area 931 (or the electronic device 200). As an example, the processor 210 may identify whether the part of the body of the user approaches the area 931 by using the first electrode 421. The processor 210 may identify whether the touch input of the user is received (or identified) in the area 931 by using the first electrode 421 and the second electrode 422.

For example, the housing of the electronic device 200 may include the first electrode 421, the second electrode 422, and the substrate 432, to provide the area 931 for receiving the touch input. The first electrode 421 may be disposed toward the area 931. The area 931 may correspond to the first area in which the first electrode 421 is disposed on the first surface of the substrate 432.

FIG. 9C illustrates an example in which the area 931 for receiving the touch input is provided in a surface of the temple 932 of the electronic device 200, but is not limited thereto. The area 931 may be configured in at least a portion of the electronic device 200. For example, the area 931 may be configured in at least a portion of a rim 933 and/or a display 934 configured in the electronic device 200.

Referring to FIG. 9D, the electronic device 200 may be configured in a form of a ring (e.g., a smart ring). The electronic device 200 may be configured to be worn on another part (e.g., a finger) of the body of the user. A portion of a housing of the electronic device 200 may include an area 941 for receiving a touch input. The electronic device 200 may receive the touch input through the part (e.g., the hand or the finger) of the body of the user in the area 941. The electronic device 200 may identify the part of the body of the user approaching the area 941 (or the electronic device 200). As an example, the processor 210 may identify whether the part of the body of the user approaches the area 941 by using the first electrode 421. The processor 210 may identify whether the touch input of the user is received (or identified) in the area 941 by using the first electrode 421 and the second electrode 422.

For example, the housing of the electronic device 200 may include the first electrode 421, the second electrode 422, and the substrate 432, to provide the area 941 for receiving the touch input. The first electrode 421 may be disposed toward the area 941. The area 941 may correspond to the first area in which the first electrode 421 is disposed on the first surface of the substrate 432.

For example, the housing of the electronic device 200 may include at least one layer. Each of the at least one layer may include a substrate (e.g., the substrate 432). The first electrode 421, the second electrode 422, and the substrate 432 may be included in one of the at least one layer included in the housing of the electronic device 200.

Referring to FIGS. 9A, 9B, 9C, and 9D, shapes of the first electrode 421, the second electrode 422, and the substrate 432 may be configured in various ways. For example, the shapes of the first electrode 421, the second electrode 422, and the substrate 432 may be set to one of the shapes illustrated in FIGS. 8A to 8C.

According to an embodiment, the electronic device 200 may be configured in a shape distinguished from the shape illustrated in FIGS. 9A to 9D. For example, the electronic device 200 may be an electronic device for providing an area in which a touch input is performed.

Referring to FIGS. 9A, 9B, 9C, and 9D, a structure including the first electrode 421, the second electrode 422, and the substrate 432 may be used to identify a touch input for a narrow area. The structure may provide an area for identifying a touch input in a narrow space. Therefore, the structure may be included in a device with a small shape size (e.g., a wearable device). According to the above-described embodiment, since assembly is simplified, assembly productivity may be increased.

An example in which the structure including the first electrode 421, the second electrode 422, and the substrate 432 is used to identify the touch input for the narrow area has been illustrated, but is not limited thereto. For example, the electronic device 200 may include a plurality of structures including the first electrode 421, the second electrode 422, and the substrate 432. The electronic device 200 may identify a touch input for a wide area based on the plurality of structures. As an example, the electronic device 200 may configure a touch screen based on the plurality of structures.

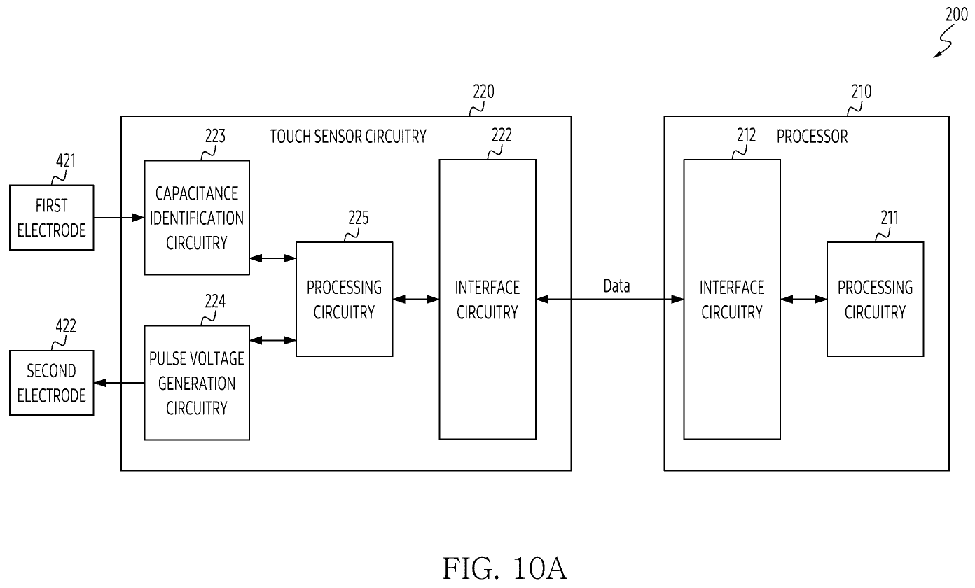

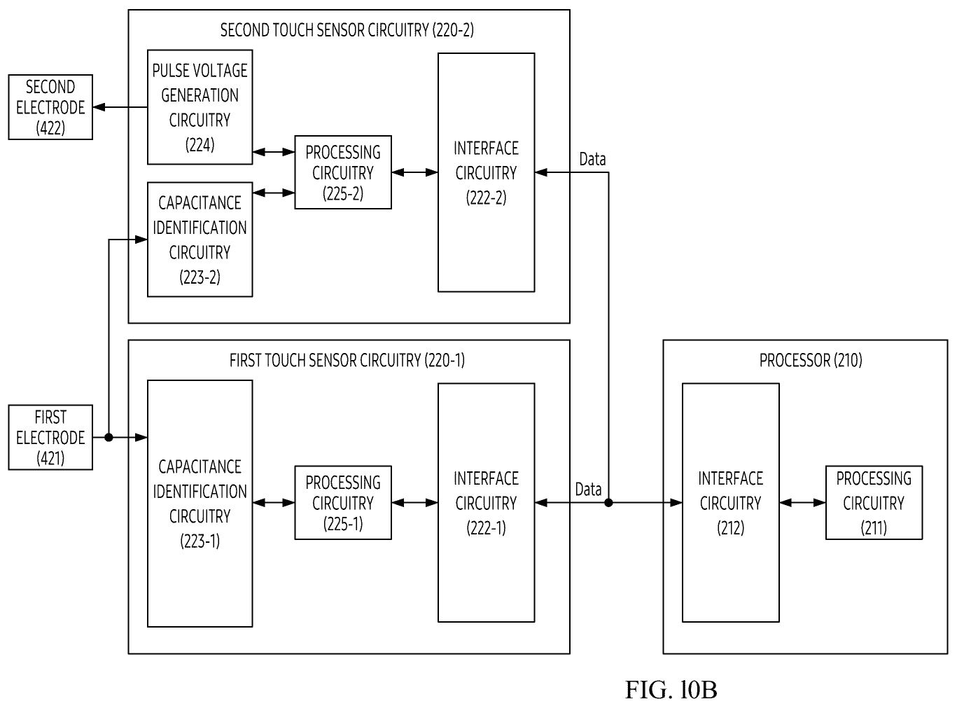

FIG. 10A illustrates an example of a block diagram of an electronic device according to an embodiment of the disclosure.

FIG. 10B illustrates an example of a block diagram of an electronic device according to an embodiment of the disclosure.

Referring to FIG. 10A, an electronic device 200 may include at least one of a first electrode 421, a second electrode 422, a processor 210, and/or touch sensor circuitry 220. For example, at least a portion of the first electrode 421, the second electrode 422, the processor 210, and the touch sensor circuitry 220 may be omitted according to an embodiment. The first electrode 421, the second electrode 422, the processor 210, and the touch sensor circuitry 220 may be electronically and/or operably coupled with each other by an electronical component such as a communication bus. Hereinafter, hardware being operably coupled may mean that a direct connection or an indirect connection between the hardware is established by wire or wirelessly, so that second hardware is controlled by first hardware among the hardware. Although illustrated based on different blocks, an embodiment is not limited thereto, and a portion of hardware of FIG. 2A (e.g., at least a portion of the processor 210 and the touch sensor circuitry 220) may be included in a single integrated circuit such as a system on a chip (SoC). A type and/or the number of hardware included in the electronic device 200 is not limited as illustrated in FIG. 10A.

According to an embodiment, the processor 210 of the electronic device 200 may include hardware for processing data based on one or more instructions. The hardware for processing data may include, for example, an arithmetic and logic unit (ALU), a floating point unit (FPU), a field programmable gate array (FPGA), a central processing unit (CPU), and/or an application processor (AP). The processor 210 may have a structure of a single-core processor, or may have a structure of a multi-core processor such as a dual core, a quad core, or a hexa core.

For example, the processor 210 of the electronic device 200 may include at least one of processing circuitry 211 and/or interface circuitry 212. As an example, the processing circuitry 211 may be used to process data received through the touch sensor circuitry 220. The processing circuitry 211 may be used to control the touch sensor circuitry 220. The processing circuitry 211 may transmit data obtained through the touch sensor circuitry 220 to another component distinguished from the touch sensor circuitry 220 or may transmit data obtained from another component to the touch sensor circuitry 220. As an example, the interface circuitry 212 may support one or more protocols that may be used to be connected to the touch sensor circuitry 220. For example, the processor 210 may be referred to as a microcontroller unit (MCU).

According to an embodiment, the touch sensor circuitry 220 may include at least one of processing circuitry 225, interface circuitry 222, capacitance identification circuitry 223, and/or pulse voltage generation circuitry 224. For example, the processing circuitry 225 may be used to process data received through the processor 210. The processing circuitry 225 may be used to control the interface circuitry 222, the capacitance identification circuitry 223, and/or the pulse voltage generation circuitry 224. The processing circuitry 225 may control the capacitance identification circuitry 223 to identify capacitance identified in the first electrode 421. The processing circuitry 225 may control the pulse voltage generation circuitry 224 to apply a pulse voltage to the second electrode 422. As an example, the first electrode 421 may be referred to as an RX electrode. The second electrode 422 may be referred to as a TX electrode.

For example, the processing circuitry 225 may identify first capacitance through the first electrode 421 while a voltage is not applied through the pulse voltage generation circuitry 224. As an example, the first capacitance may mean capacitance identified through a single electrode. For example, the processing circuitry 225 may apply a pulse voltage to the second electrode 422 based on a specified time period through the pulse voltage generation circuitry 224. The processing circuitry 225 may identify second capacitance while the pulse voltage is applied to the second electrode 422. As an example, the second capacitance may mean capacitance between a plurality of electrodes. As an example, the second capacitance may mean capacitance between the first electrode 421 and the second electrode 422.

Referring to FIG. 10B, the touch sensor circuitry 220 of FIG. 10A may be divided into first touch sensor circuitry 220-1 and second touch sensor circuitry 220-2.

For example, the second touch sensor circuitry 220-2 may include functional blocks for operating as a mutual capacitance system. For example, the second touch sensor circuitry 220-2 may be used to identify the second capacitance for the first electrode 421 and the second electrode 422. For example, the second touch sensor circuitry 220-2 may include at least one of pulse voltage generation circuitry 224, capacitance identification circuitry 223-2, processing circuitry 225-2, and/or interface circuitry 222-2. For example, the second touch sensor circuitry 220-2 may include functional blocks for identifying the second capacitance among functional blocks of the touch sensor circuitry 220 of FIG. 10A. As an example, the processing circuitry 225-2 may be set to perform a function for identifying the second capacitance.

For example, the first touch sensor circuitry 220-1 may include functional blocks for operating as a self capacitance system. For example, the first touch sensor circuitry 220-1 may be used to identify the first capacitance for the first electrode 421. For example, the first touch sensor circuitry 220-1 may include at least one of capacitance identification circuitry 223-1, processing circuitry 225-1, and/or interface circuitry 222-1. For example, the first touch sensor circuitry 220-1 may include functional blocks for identifying the first capacitance among functional blocks of the touch sensor circuitry 220 of FIG. 10A. As an example, the processing circuitry 225-1 may be set to perform a function for identifying the first capacitance.

According to an embodiment, the processor 210 may identify the first capacitance based on deactivating the second touch sensor circuitry 220-2 and activating the first touch sensor circuitry 220-1. The processor 210 may identify the second capacitance based on activating the second touch sensor circuitry 220-2 and deactivating the first touch sensor circuitry 220-1.

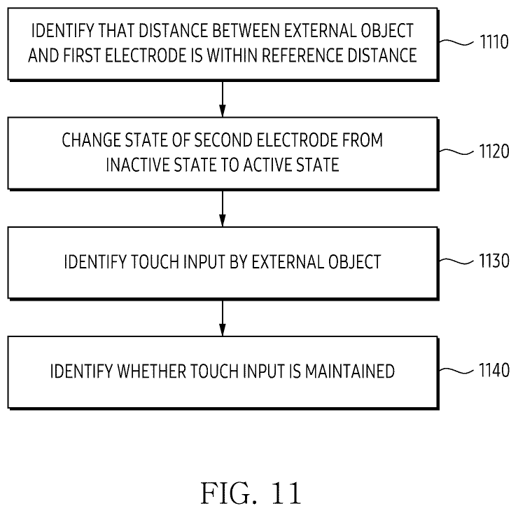

FIG. 11 illustrates a flowchart of an operation of an electronic device according to an embodiment of the disclosure.

In the following embodiment, each of the operations may be sequentially performed, but is not necessarily performed sequentially. For example, an order of each of the operations may be changed, and at least two operations may be performed in parallel.

Referring to FIG. 11, in operation 1110, a processor 210 may identify that a distance between an external object 240 and a first electrode 421 is within a reference distance. For example, the processor 210 may identify that the distance between the external object 240 and the first electrode 421 is within the reference distance based on a first capacitance value identified through the first electrode 421.

For example, the external object 240 may include a part of a body of a user. As an example, the external object 240 may include a hand and/or a finger of the user. For example, the external object 240 may include a device for performing a touch input. As an example, the external object 240 may include a device including ground.

For example, the processor 210 may identify the first capacitance value through the first electrode 421. As an example, the processor 210 may identify (or monitor) the first capacitance value through the first electrode 421 while a state of a second electrode 422 is in an inactive state. The processor 210 may identify a capacitance value identified between the first electrode 421 and the external object 240 as the first capacitance value while a reference signal (e.g., a pulse voltage) is not applied to the second electrode 422. As an example, the processor 210 may identify the first capacitance value using a self capacitance system.

For example, the processor 210 may identify that the distance between the external object 240 and the first electrode 421 is within the reference distance based on identifying that the first capacitance value is greater than a first value. As an example, as the external object 240 approaches the first electrode 421, the first capacitance value may increase. In a case that the first capacitance value is greater than the first value, the processor 210 may identify that the distance between the external object 240 and the first electrode 421 is within the reference distance.

According to an embodiment, the processor 210 may identify that the first capacitance value is greater than the first value. The processor 210 may perform operation 1120 based on identifying that the first capacitance value is greater than the first value. For example, regardless of the distance between the external object 240 and the first electrode 421, the processor 210 may perform the operation 1120 based on identifying that the first capacitance value is greater than the first value.

In the operation 1120, the processor 210 may change the state of the second electrode 422 from the inactive state to an active state. For example, the processor 210 may change the state of the second electrode 422 from the inactive state to the active state based on identifying that the distance between the external object 240 and the first electrode 421 is within the reference distance.

For example, the state of the second electrode 422 may be one of the inactive state and the active state. The processor 210 may change the state of the second electrode 422 from the inactive state to the active state based on applying the reference signal to the second electrode 422 using touch sensor circuitry 220. The processor 210 may change the state of the second electrode 422 from the active state to the inactive state based on ceasing applying the reference signal to the second electrode 422 using the touch sensor circuitry 220. As an example, the reference signal may include a pulse signal (or a pulse voltage) that is repeated according to a specified time period.

According to an embodiment, the processor 210 may identify a second capacitance value through the first electrode 421 and the second electrode 422. For example, the processor 210 may identify the second capacitance value through the first electrode 421 and the second electrode 422 while the state of the second electrode 422 is in the active state. The processor 210 may identify a capacitance value identified between the first electrode 421 and the second electrode 422 as the second capacitance value while the reference signal is applied to the second electrode 422. As an example, the processor 210 may identify the second capacitance value using a mutual capacitance system.

For example, the processor 210 may identify both the first capacitance value and the second capacitance value. The processor 210 may monitor both the first capacitance value and the second capacitance value.

The first capacitance value and the second capacitance value described below may be changed. For example, the first capacitance value may mean a value monitored through the first electrode 421. The second capacitance value may mean a value monitored through the first electrode 421 and the second electrode 422. The first capacitance value and the second capacitance value may be changed according to time or a situation.

For example, the processor 210 may identify the first capacitance value and the second capacitance value based on a regular time period. As an example, within a first time interval, the processor 210 may identify the first capacitance value. Within a second time interval distinguished from the first time interval, the processor 210 may identify the second capacitance value.

For example, the processor 210 may apply a specified voltage according to the specified time period based on the reference signal. The processor 210 may identify the second capacitance value while the specified voltage is applied to the second electrode 422. The processor 210 may identify the first capacitance value while a voltage is not applied to the second electrode 422.

According to an embodiment, the processor 210 may distinguish whether the external object 240 approaching the first electrode 421 is a part of the body of the user or a foreign substance 340 including moisture.

For example, the processor 210 may identify that the first capacitance value increases and the second capacitance value decreases while the state of the second electrode 422 is in the active state. The processor 210 may identify the external object 240 as the part of the body of the user based on identifying that the first capacitance value increases and the second capacitance value decreases.

For example, the processor 210 may identify that both the first capacitance value and the second capacitance value increase while the state of the second electrode 422 is in the active state. Based on identifying that both the first capacitance value and the second capacitance value increase, the processor 210 may identify that the external object 240 is distinguished from the part of the body of the user of an electronic device 200 (e.g., the foreign substance 340).

In operation 1130, the processor 210 may identify a touch input by the external object 240. For example, the processor 210 may identify the touch input by the external object 240 based on the first capacitance value and the second capacitance value.

For example, the processor 210 may identify the touch input by the external object 240 based on identifying that the first capacitance value is greater than a second value greater than the first value and the second capacitance value is less than a third value.

For example, the processor 210 may change the state of the second electrode 422 from the active state to the inactive state in response to the touch input. For example, the processor 210 may cease identifying (or monitoring) the second capacitance value in response to identifying the touch input by the external object 240. The processor 210 may identify (or monitor) only the first capacitance value.

According to an embodiment, the processor 210 may identify the touch input by the external object 240 based on identifying that the first capacitance value is greater than the second value greater than the first value or that the second capacitance value is less than the third value.

According to an embodiment, the processor 210 may cease identifying (or monitoring) the second capacitance value based on identifying that the first capacitance value is reduced to less than or equal to the first value. The processor 210 may identify that the distance between the external object 240 and the first electrode 421 deviates from the reference distance based on identifying that the first capacitance value is reduced to less than or equal to the first value. The processor 210 may identify that a touch intention of the user of the electronic device 200 has disappeared. The processor 210 may cease identifying (or monitoring) the second capacitance value. The processor 210 may cease identifying (or monitoring) the second capacitance value to reduce power consumption, and may identify (or monitor) only the first capacitance value.

In operation 1140, the processor 210 may identify whether the touch input is maintained. For example, the processor 210 may identify whether the touch input is maintained based on the first capacitance value.

For example, the processor 210 may identify that the touch input is not maintained based on identifying that the first capacitance value is changed to be less than or equal to the second value. The processor 210 may change the state of the second electrode 422 from the inactive state to the active state based on identifying that the touch input is not maintained.

For example, the processor 210 may change the state of the second electrode 422 from the inactive state to the active state to identify whether another touch input (or an additional touch input) is received. As an example, the processor 210 may identify another touch input by the external object 240 based on the first capacitance value and the second capacitance value. After identifying the touch input in the operation 1130, the processor 210 may identify the other touch input by the external object 240 based on identifying that the first capacitance value is greater than the second value greater than the first value and the second capacitance value is less than the third value. The processor 210 may identify that a time interval between a first timing at which the touch input is identified and a second timing at which the other touch input is identified is within a reference time interval. The processor 210 may identify the touch input and the other touch input as a double tap input based on identifying that the time interval between the first timing and the second timing is within the reference time interval. As in the above-described example, the processor 210 may identify three consecutive touch inputs as a triple tap input.

According to an embodiment, after identifying the touch input, the processor 210 may change the state of the second electrode 422 from the active state to the inactive state based on identifying that the distance between the external object 240 and the first electrode 421 deviates from the reference distance. For example, the processor 210 may identify that the distance between the external object 240 and the first electrode 421 deviates from the reference distance based on identifying that the first capacitance value is changed to be less than or equal to the first value. The processor 210 may change the state of the second electrode 422 from the active state to the inactive state based on identifying that the first capacitance value is changed to be less than or equal to the first value.

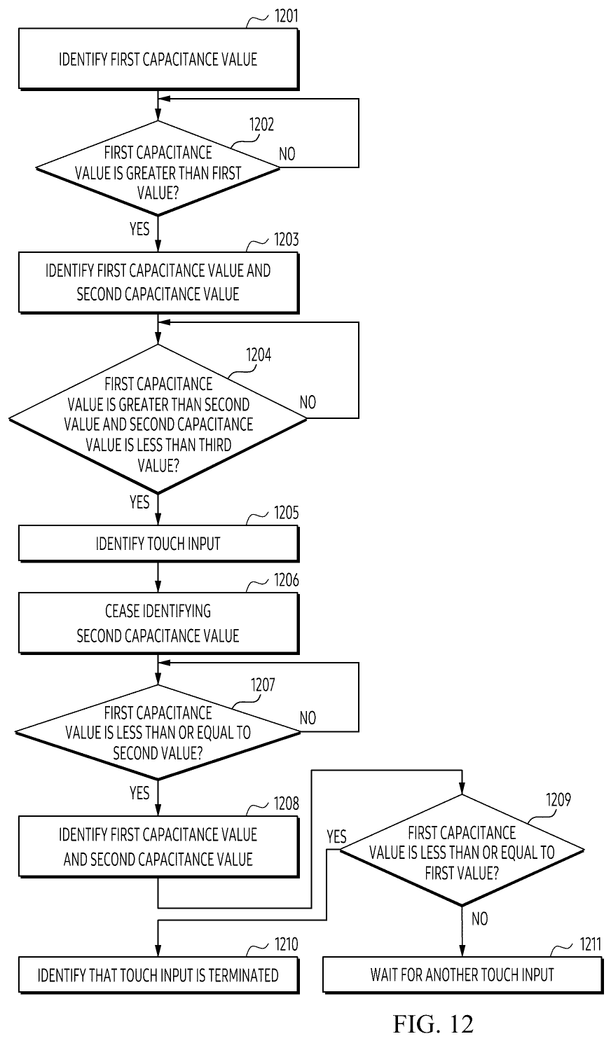

FIG. 12 illustrates a flowchart of an operation of an electronic device according to an embodiment of the disclosure. Operation 1201 to operation 1211 illustrated in FIG. 12 may correspond to the operation 1110 to the operation 1140 of FIG. 11. In the following embodiment, each of the operations may be sequentially performed, but is not necessarily performed sequentially. For example, an order of each of the operations may be changed, and at least two operations may be performed in parallel.

Referring to FIG. 12, in operation 1201, a processor 210 may identify a first capacitance value. For example, the processor 210 may monitor the first capacitance value. The processor 210 may identify whether an external object 240 approaches based on the first capacitance value. For example, the processor 210 may identify the first capacitance value using a self capacitance system. The processor 210 may identify the first capacitance value while a state of a second electrode 422 is in an inactive state.

In operation 1202, the processor 210 may identify whether the first capacitance value is greater than a first value. For example, the processor 210 may identify that the external object 240 approaches a first electrode 421 based on identifying that the first capacitance value increases.

According to an embodiment, in a case that the first capacitance value is less than or equal to the first value (no in the operation 1202), the processor 210 may maintain identifying the first capacitance value.

In operation 1203, in a case that the first capacitance value is greater than the first value (yes in the operation 1202), the processor 210 may identify the first capacitance value and a second capacitance value. For example, the processor 210 may identify the first capacitance value and the second capacitance value based on identifying that the first capacitance value is greater than the first value. The processor 210 may repeatedly identify (or monitor) the first capacitance value and the second capacitance value based on a specified time period.

According to an embodiment, the processor 210 may change the state of the second electrode 422 from the inactive state to an active state based on identifying that the first capacitance value is greater than the first value. The processor 210 may apply a reference signal to the second electrode 422 based on identifying that the first capacitance value is greater than the first value. For example, the reference signal may be configured with a square wave. For example, the reference signal may include a pulse wave configured based on the specified time period.

For example, the processor 210 may identify the first capacitance value using the self capacitance system and identify the second capacitance value using a mutual capacitance system. The processor 210 may switch the self capacitance system and the mutual capacitance system according to whether the reference signal is applied to the second electrode 422.

In operation 1204, the processor 210 may identify whether the first capacitance value is greater than a second value and the second capacitance value is less than a third value. For example, the processor 210 may identify whether a touch input is received based on whether the first capacitance value is greater than the second value and the second capacitance value is less than the third value.

According to an embodiment, the processor 210 may distinguish whether an external object 240 approaching the first electrode 421 is a part of a body of a user or a foreign substance 340 including moisture.

For example, the processor 210 may identify that the first capacitance value increases and the second capacitance value decreases while the state of the second electrode 422 is in the active state. The processor 210 may identify the external object 240 as the part of the body of the user based on identifying that the first capacitance value increases and the second capacitance value decreases.

For example, the processor 210 may identify that both the first capacitance value and the second capacitance value increase while the state of the second electrode 422 is in the active state. Based on identifying that both the first capacitance value and the second capacitance value increase, the processor 210 may identify that the external object 240 is distinguished from the part of the body of the user of an electronic device 200 (e.g., the foreign substance 340).

According to an embodiment, in a case that the first capacitance value is greater than the second value and the second capacitance value is not less than the third value (no in the operation 1204), the processor 210 may maintain identifying the first capacitance value and the second capacitance value. For example, the processor 210 may maintain identifying the first capacitance value and the second capacitance value based on identifying that the first capacitance value is greater than the second value and the second capacitance value is not less than the third value.

In operation 1205, in a case that the first capacitance value is greater than the second value and the second capacitance value is less than the third value (yes in the operation 1204), the processor 210 may identify the touch input. For example, the processor 210 may identify a touch input by the external object 240 based on identifying that the first capacitance value is greater than the second value and the second capacitance value is less than the third value.

For example, the processor 210 may identify that the external object 240 contacts the electronic device 200 (or an overlay 431), based on identifying that the first capacitance value is greater than the second value and the second capacitance value is less than the third value. As an example, the processor 210 may identify that the external object 240 contacts an area corresponding to the first electrode 421 based on identifying that the first capacitance value is greater than the second value and the second capacitance value is less than the third value.

In operation 1206, the processor 210 may cease identifying the second capacitance value. For example, the processor 210 may cease identifying (or monitoring) the second capacitance value in response to identifying the touch input. The processor 210 may maintain identification (or monitoring) of the first capacitance value. For example, in response to identifying the touch input, the processor 210 may identify whether the touch input is maintained, using the self capacitance system. For example, since the processor 210 identifies the touch input, it may identify whether the touch input is maintained to reduce an unnecessary sequence and/or current consumption, using the self capacitance system.

In operation 1207, the processor 210 may identify whether the first capacitance value is less than or equal to the second value. For example, after ceasing identification of the second capacitance value, the processor 210 may identify whether the first capacitance value is less than or equal to the second value. The processor 210 may identify whether the touch input has been released, using only the first capacitance value.

According to an embodiment, in a case that the first capacitance value is not less than the second value (no in the operation 1207), the processor 210 may maintain identifying the first capacitance value.

In operation 1208, in a case that the first capacitance value is less than or equal to the second value, the processor 210 may identify the first capacitance value and the second capacitance value. For example, the processor 210 may identify the first capacitance value and the second capacitance value based on identifying that the first capacitance value is less than or equal to the second value. For example, the operation 1208 may correspond to the operation 1203.

In operation 1209, the processor 210 may identify whether the first capacitance value is less than or equal to the first value. The processor 210 may identify whether the first capacitance value is less than or equal to the first value to identify whether the touch input is terminated.

In operation 1210, in a case that the first capacitance value is less than or equal to the first value (yes in the operation 1209), the processor 210 may identify that the touch input is terminated. For example, the processor 210 may identify that the touch input is terminated based on identifying that the first capacitance value is less than or equal to the first value.

In operation 1211, in a case that the first capacitance value is not less than or equal to the first value (no in the operation 1209), the processor 210 may wait for another touch input. For example, the processor 210 may wait for the other touch input based on identifying that the first capacitance value is not less than or equal to the first value.

For example, the processor 210 may identify another touch input by the external object 240 based on the first capacitance value and the second capacitance value. After identifying the touch input, the processor 210 may identify the other touch input by the external object 240 based on identifying that the first capacitance value is greater than the second value greater than the first value and the second capacitance value is less than the third value. The processor 210 may identify that a time interval between a first timing at which the touch input is identified and a second timing at which the other touch input is identified is within a reference time interval. The processor 210 may identify the touch input and the other touch input as a double tap input based on identifying that the time interval between the first timing and the second timing is within the reference time interval. As in the above-described example, the processor 210 may identify three consecutive touch inputs as a triple tap input. The processor 210 may perform an operation (e.g., play music or stop music) according to each of the touch input, the double tap input, or the triple tap input.

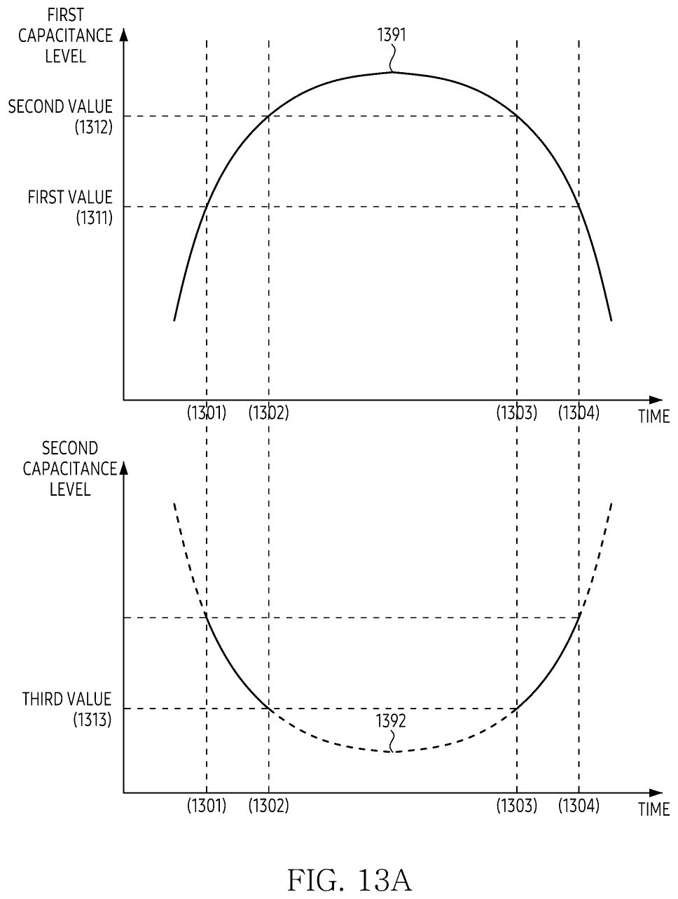

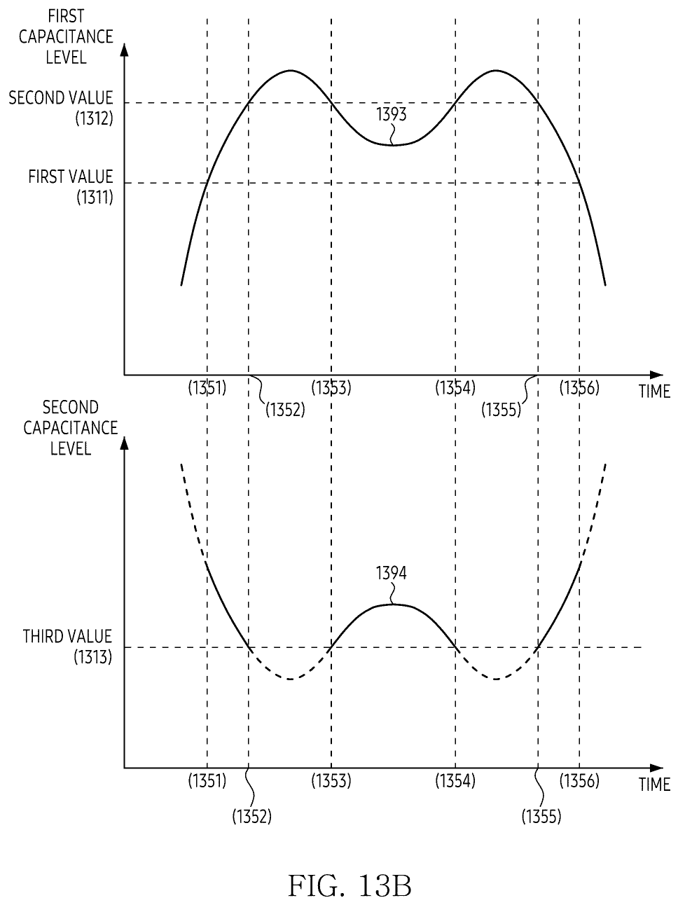

FIG. 13A illustrates a change in a first capacitance value and a second capacitance value in a case that a tap input is generated, according to an embodiment of the disclosure.

FIG. 13B illustrates a change in a first capacitance value and a second capacitance value in a case that a double tap input is generated, according to an embodiment of the disclosure.

Referring to FIG. 13A, a processor 210 may operate based on the operation 1201 to the operation 1211 of FIG. 12. A graph 1391 indicates a first capacitance value over time. A graph 1392 indicates a second capacitance value over time.

According to an embodiment, the processor 210 may identify (or monitor) the first capacitance value before a timing 1301.

At the timing 1301, the processor 210 may identify that the first capacitance value is greater than a first value 1311. Based on identifying that the first capacitance value is greater than the first value 1311, the processor 210 may identify that a distance between an external object 240 and a first electrode 421 is within a reference distance. According to an embodiment, the processor 210 may identify the second capacitance value based on identifying that the first capacitance value is greater than the first value 1311.

From the timing 1301 to a timing 1302, the processor 210 may identify that the first capacitance value increases and the second capacitance value decreases. The processor 210 may identify that the external object 240 is a part of a body of a user based on identifying that the first capacitance value increases and the second capacitance value decreases.

At the timing 1302, the processor 210 may identify that the first capacitance value is greater than a second value 1312 and the second capacitance value is less than a third value 1313. The processor 210 may identify a touch input by the external object 240 based on identifying that the first capacitance value is greater than the second value 1312 and the second capacitance value is less than the third value 1313. In response to identifying the touch input, the processor 210 may cease identifying the second capacitance value.

Referring to FIG. 13A, for convenience of explanation, an example in which a timing at which the first capacitance value is greater than the second value 1312 and the second capacitance value is less than the third value 1313 is set to be the same is illustrated, but is not limited thereto. A timing at which the first capacitance value is greater than the second value 1312 and a timing at which the second capacitance value is less than the third value 1313 may be different from each other. The processor 210 may identify that the first capacitance value is greater than the second value 1312 and that the second capacitance value is less than the third value 1313 at a later timing among the timing at which the first capacitance value is greater than the second value 1312 and the timing at which the second capacitance value is less than the third value 1313.

From the timing 1302 to a timing 1303, the processor 210 may identify that the first capacitance value is maintained within a range greater than the second value 1312. The processor 210 may identify that the touch input is maintained based on identifying that the first capacitance value is maintained within the range greater than the second value 1312.

At the timing 1303, the processor 210 may identify that the first capacitance value is less than or equal to the second value 1312. The processor 210 may identify that the touch input has been released based on identifying that the first capacitance value is less than or equal to the second value 1312. The processor 210 may identify the second capacitance value based on identifying that the first capacitance value is less than or equal to the second value 1312.

From the timing 1303 to a timing 1304, the processor 210 may identify whether another touch input is identified based on the first capacitance value and the second capacitance value.

At the timing 1304, the processor 210 may cease identifying the second capacitance value based on identifying that the first capacitance value is less than or equal to the first value 1311. The processor 210 may identify that one touch input has been received from the timing 1301 to the timing 1304.

Referring to FIG. 13B, a graph 1393 indicates a first capacitance value over time. A graph 1394 indicates a second capacitance value over time.

According to an embodiment, the processor 210 may identify (or monitor) the first capacitance value before a timing 1351.

At the timing 1351, the processor 210 may identify that the first capacitance value is greater than the first value 1311. Based on identifying that the first capacitance value is greater than the first value 1311, the processor 210 may identify that a distance between an external object 240 and a first electrode 421 is within a reference distance. According to an embodiment, the processor 210 may identify the second capacitance value based on identifying that the first capacitance value is greater than the first value 1311.

From the timing 1351 to a timing 1352, the processor 210 may identify that the first capacitance value increases and the second capacitance value decreases. The processor 210 may identify that the external object 240 is a part of a body of a user based on identifying that the first capacitance value increases and the second capacitance value decreases.

At the timing 1352, the processor 210 may identify that the first capacitance value is greater than the second value 1312 and the second capacitance value is less than the third value 1313. The processor 210 may identify a first touch input by the external object 240 based on identifying that the first capacitance value is greater than the second value 1312 and the second capacitance value is less than the third value 1313. In response to identifying the first touch input, the processor 210 may cease identifying the second capacitance value.

Referring to FIG. 13B, for convenience of explanation, an example in which a timing at which the first capacitance value is greater than the second value 1312 and the second capacitance value is less than the third value 1313 is set to be the same is illustrated, but is not limited thereto. A timing at which the first capacitance value is greater than the second value 1312 and a timing at which the second capacitance value is less than the third value 1313 may be different from each other. The processor 210 may identify that the first capacitance value is greater than the second value 1312 and that the second capacitance value is less than the third value 1313 at a later timing among the timing at which the first capacitance value is greater than the second value 1312 and the timing at which the second capacitance value is less than the third value 1313.

From the timing 1352 to a timing 1353, the processor 210 may identify that the first capacitance value is maintained within a range greater than the second value 1312. The processor 210 may identify that the first touch input is maintained based on identifying that the first capacitance value is maintained within the range greater than the second value 1312.

At the timing 1353, the processor 210 may identify that the first capacitance value is less than or equal to the second value 1312. The processor 210 may identify that the first touch input has been released based on identifying that the first capacitance value is less than or equal to the second value 1312. The processor 210 may identify the second capacitance value based on identifying that the first capacitance value is less than or equal to the second value 1312.

From the timing 1353 to a timing 1354, the processor 210 may identify whether a second touch input is identified based on the first capacitance value and the second capacitance value.

At the timing 1354, the processor 210 may identify that the first capacitance value is greater than the second value 1312 and the second capacitance value is less than the third value 1313. The processor 210 may identify the second touch input by the external object 240 based on identifying that the first capacitance value is greater than the second value 1312 and the second capacitance value is less than the third value 1313. In response to identifying the second touch input, the processor 210 may cease identifying the second capacitance value.

From the timing 1354 to a timing 1355, the processor 210 may identify that the first capacitance value is maintained within the range greater than the second value 1312. The processor 210 may identify that the second touch input is maintained based on identifying that the first capacitance value is maintained within the range greater than the second value 1312.

At the timing 1355, the processor 210 may identify that the first capacitance value is less than or equal to the second value 1312. The processor 210 may identify that the second touch input has been released based on identifying that the first capacitance value is less than or equal to the second value 1312. The processor 210 may identify the second capacitance value based on identifying that the first capacitance value is less than or equal to the second value 1312.

From the timing 1355 to a timing 1356, the processor 210 may identify whether another touch input, which is distinguished from the first touch input and the second touch input, is identified based on the first capacitance value and the second capacitance value.

At the timing 1356, the processor 210 may cease identifying the second capacitance value based on identifying that the first capacitance value is less than or equal to the first value 1311. The processor 210 may identify that two touch inputs have been received from the timing 1351 to the timing 1356. The processor 210 may identify that a double tap input has been received based on identifying that a time interval between the timing 1352 and the timing 1355 is within a reference time interval.

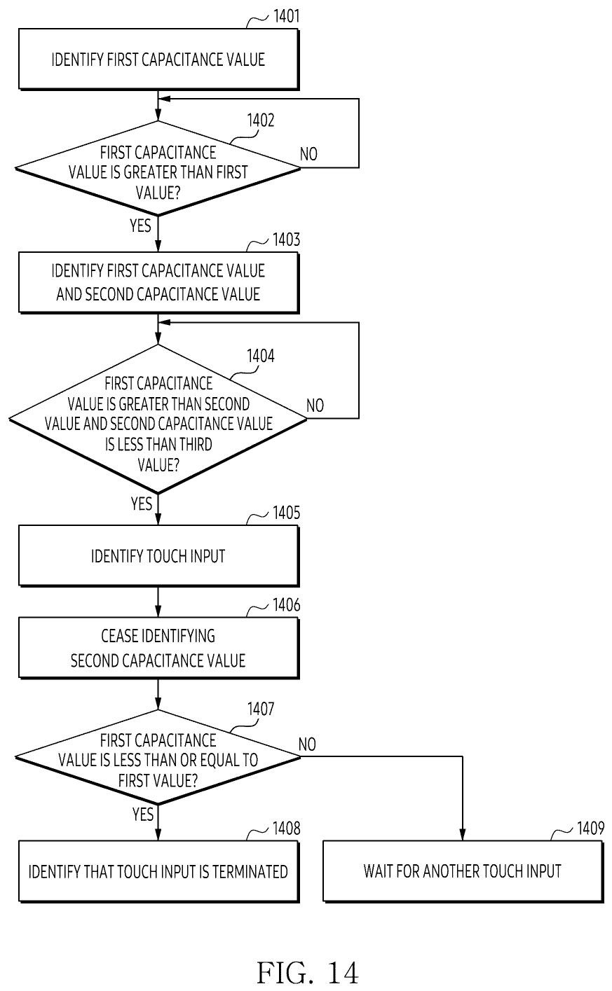

FIG. 14 illustrates a flowchart of an operation of an electronic device according to an embodiment of the disclosure. Operation 1401 to operation 1209 illustrated in FIG. 14 may correspond to the operation 1110 to the operation 1140 of FIG. 11. In the following embodiment, each of the operations may be sequentially performed, but is not necessarily performed sequentially. For example, an order of each of the operations may be changed, and at least two operations may be performed in parallel.

The operations 1401, 1402, 1403, 1404, 1404 and 1406 may correspond to the operations 1201, 1202, 1203, 1204, 1205 and 1206 of FIG. 12.

Referring to FIG. 14, in operation 1407, a processor 210 may identify whether a first capacitance value is less than or equal to a first value. The processor 210 may identify whether the first capacitance value is less than or equal to the first value to identify whether a touch input is terminated.

In operation 1408, in a case that the first capacitance value is less than or equal to the first value (yes in the operation 1407), the processor 210 may identify that the touch input is terminated. For example, the processor 210 may identify that the touch input is terminated based on identifying that the first capacitance value is less than or equal to the first value. The operation 1408 may correspond to the operation 1210 of FIG. 12.

In operation 1409, in a case that the first capacitance value is not less than or equal to the first value (no in the operation 1407), the processor 210 may wait for another touch input. For example, the processor 210 may wait for the other touch input based on identifying that the first capacitance value is not less than or equal to the first value. The operation 1409 may correspond to the operation 1211 of FIG. 12.

In the operation 1407 to the operation 1409, the processor 210 may not identify a second capacitance value even in a case that the first capacitance value becomes smaller than a second value after the touch input is identified. The processor 210 may identify whether the other touch input is identified through the first capacitance value while a state of a second electrode 422 is in an inactive state.

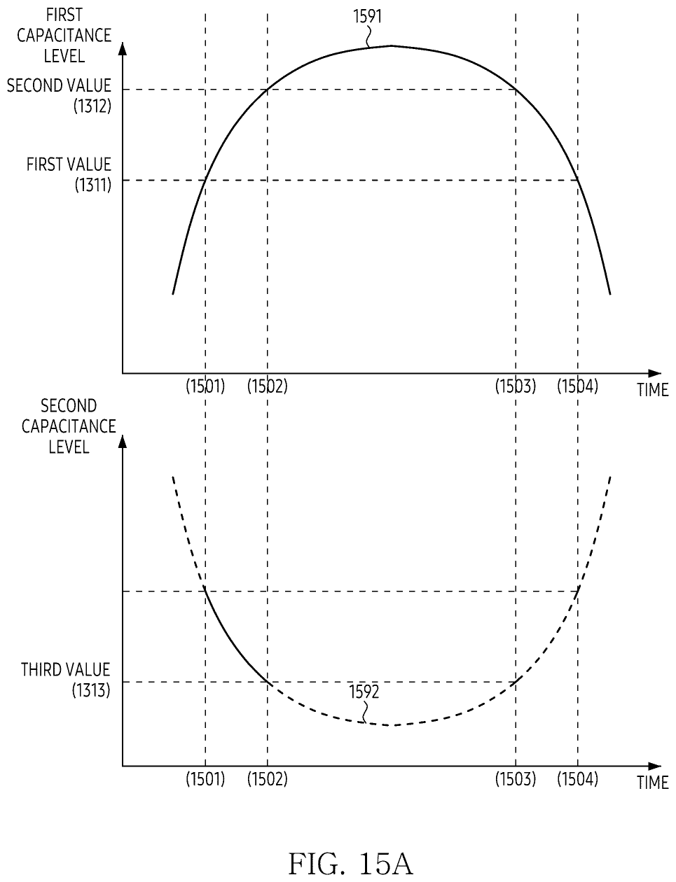

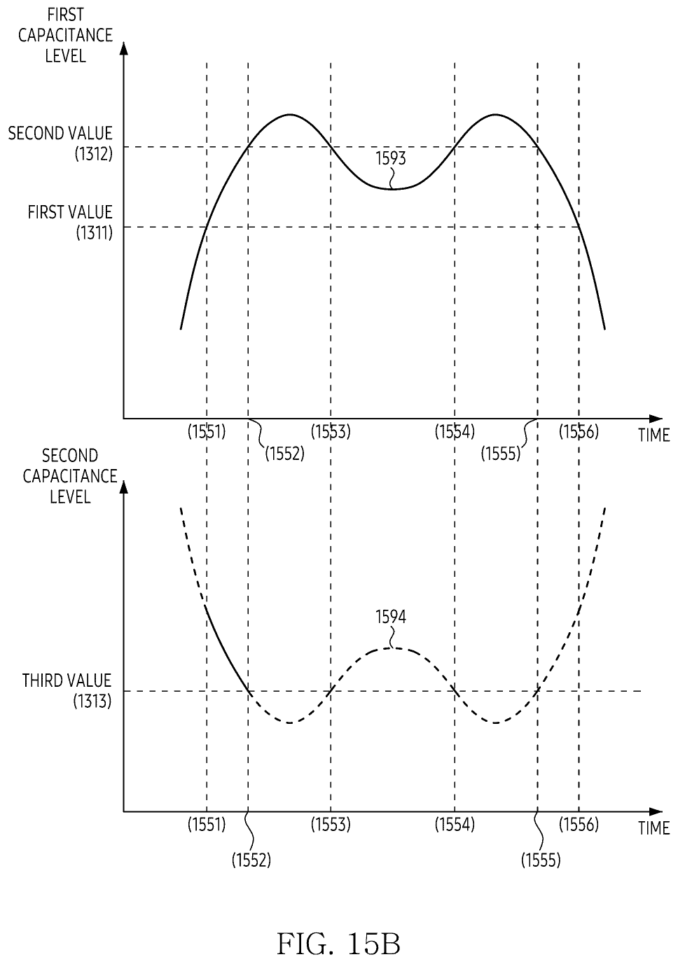

FIG. 15A illustrates a change in a first capacitance value and a second capacitance value in a case that a tap input is generated, according to an embodiment of the disclosure.

FIG. 15B illustrates a change in a first capacitance value and a second capacitance value in a case that a double tap input is generated, according to an embodiment of the disclosure.

Referring to FIG. 15A, a processor 210 may operate based on the operation 1401 to the operation 1409 of FIG. 14. A graph 1591 indicates a first capacitance value over time. A graph 1592 indicates a second capacitance value over time.

According to an embodiment, the processor 210 may identify (or monitor) the first capacitance value before a timing 1501.

At the timing 1501, the processor 210 may identify that the first capacitance value is greater than a first value 1311. Based on identifying that the first capacitance value is greater than the first value 1311, the processor 210 may identify that a distance between an external object 240 and a first electrode 421 is within a reference distance. According to an embodiment, the processor 210 may identify the second capacitance value based on identifying that the first capacitance value is greater than the first value 1311.

From the timing 1501 to a timing 1502, the processor 210 may identify that the first capacitance value increases and the second capacitance value decreases. The processor 210 may identify that the external object 240 is a part of a body of a user based on identifying that the first capacitance value increases and the second capacitance value decreases.

At the timing 1502, the processor 210 may identify that the first capacitance value is greater than a second value 1312 and the second capacitance value is less than a third value 1313. The processor 210 may identify a touch input by the external object 240 based on identifying that the first capacitance value is greater than the second value 1312 and the second capacitance value is less than the third value 1313. In response to identifying the touch input, the processor 210 may cease identifying the second capacitance value.

Referring to FIG. 15A, for convenience of explanation, an example in which a timing at which the first capacitance value is greater than the second value 1312 and the second capacitance value is less than the third value 1313 is set to be the same is illustrated, but is not limited thereto. A timing at which the first capacitance value is greater than the second value 1312 and a timing at which the second capacitance value is less than the third value 1313 may be different from each other. The processor 210 may identify that the first capacitance value is greater than the second value 1312 and that the second capacitance value is less than the third value 1313 at a later timing among the timing at which the first capacitance value is greater than the second value 1312 and the timing at which the second capacitance value is less than the third value 1313.

From the timing 1502 to a timing 1503, the processor 210 may identify that the first capacitance value is maintained within a range greater than the second value 1312. The processor 210 may identify that the touch input is maintained based on identifying that the first capacitance value is maintained within the range greater than the second value 1312.

At the timing 1503, the processor 210 may identify that the first capacitance value is less than or equal to the second value 1312. Even in a case of identifying that the first capacitance value is less than or equal to the second value 1312, the processor 210 may not identify the second capacitance value. The processor 210 may identify whether another touch input is identified, using only the first capacitance value.

At the timing 1504, the processor 210 may may identify that one touch input has been received from the timing 1501 to the timing 1504 based on identifying that the first capacitance value is less than or equal to the first value 1311.

Referring to FIG. 15B, a graph 1593 indicates a first capacitance value over time. A graph 1594 indicates a second capacitance value over time.

According to an embodiment, the processor 210 may identify (or monitor) the first capacitance value before a timing 1551.

At the timing 1551, the processor 210 may identify that the first capacitance value is greater than a first value 1311. Based on identifying that the first capacitance value is greater than the first value 1311, the processor 210 may identify that a distance between an external object 240 and a first electrode 421 is within a reference distance. According to an embodiment, the processor 210 may identify the second capacitance value based on identifying that the first capacitance value is greater than the first value 1311.

From the timing 1551 to a timing 1552, the processor 210 may identify that the first capacitance value increases and the second capacitance value decreases. The processor 210 may identify that the external object 240 is a part of a body of a user based on identifying that the first capacitance value increases and the second capacitance value decreases.

At the timing 1552, the processor 210 may identify that the first capacitance value is greater than a second value 1312 and the second capacitance value is less than a third value 1313. The processor 210 may identify a first touch input by the external object 240 based on identifying that the first capacitance value is greater than the second value 1312 and the second capacitance value is less than the third value 1313. In response to identifying the first touch input, the processor 210 may cease identifying the second capacitance value.

Referring to FIG. 15B, for convenience of explanation, an example in which a timing at which the first capacitance value is greater than the second value 1312 and the second capacitance value is less than the third value 1313 is set to be the same is illustrated, but is not limited thereto. A timing at which the first capacitance value is greater than the second value 1312 and a timing at which the second capacitance value is less than the third value 1313 may be different from each other. The processor 210 may identify that the first capacitance value is greater than the second value 1312 and that the second capacitance value is less than the third value 1313 at a later timing among the timing at which the first capacitance value is greater than the second value 1312 and the timing at which the second capacitance value is less than the third value 1313.

From the timing 1552 to a timing 1553, the processor 210 may identify that the first capacitance value is maintained within a range greater than the second value 1312. The processor 210 may identify that the first touch input is maintained based on identifying that the first capacitance value is maintained within the range greater than the second value 1312.

At the timing 1553, the processor 210 may identify that the first capacitance value is less than or equal to the second value 1312. The processor 210 may identify that the first touch input has been released based on identifying that the first capacitance value is less than or equal to the second value 1312.

From the timing 1553 to a timing 1554, the processor 210 may identify whether a second touch input is identified based on the first capacitance value.

At the timing 1554, the processor 210 may identify that the first capacitance value is greater than the second value 1312. The processor 210 may identify the second touch input by the external object 240 based on identifying that the first capacitance value is greater than the second value 1312.

From the timing 1554 to a timing 1555, the processor 210 may identify that the first capacitance value is maintained within the range greater than the second value 1312. The processor 210 may identify that the second touch input is maintained based on identifying that the first capacitance value is maintained within the range greater than the second value 1312.

At the timing 1555, the processor 210 may identify that the first capacitance value is less than or equal to the second value 1312. The processor 210 may identify that the second touch input has been released based on identifying that the first capacitance value is less than or equal to the second value 1312.

From the timing 1555 to a timing 1556, the processor 210 may identify whether another touch input, which is distinguished from the first touch input and the second touch input, is identified based on the first capacitance value.

At the timing 1556, the processor 210 may identify that two touch inputs have been received from the timing 1551 to the timing 1556 based on identifying that the first capacitance value is less than or equal to the first value 1311. The processor 210 may identify that a double tap input has been received based on identifying that a time interval between the timing 1552 and the timing 1555 is within a reference time interval.

According to the above-described embodiment, the processor 210 may identify the first capacitance value and the second capacitance value from the timing 1551 to the timing 1552. The processor 210 may identify that the external object 240 is the part of the body of the user based on identifying that the first capacitance value increases and the second capacitance value decreases. Since the processor 210 identifies that the external object 240 is the part of the body of the user, the second capacitance value may not be identified from the timing 1553 to the timing 1554. Since the processor 210 identifies that the external object 240 is the part of the body of the user, the second capacitance value may not be identified from the timing 1555 to the timing 1556. After receiving one touch input, the processor 210 may identify an additionally received touch input using only a self capacitance system.

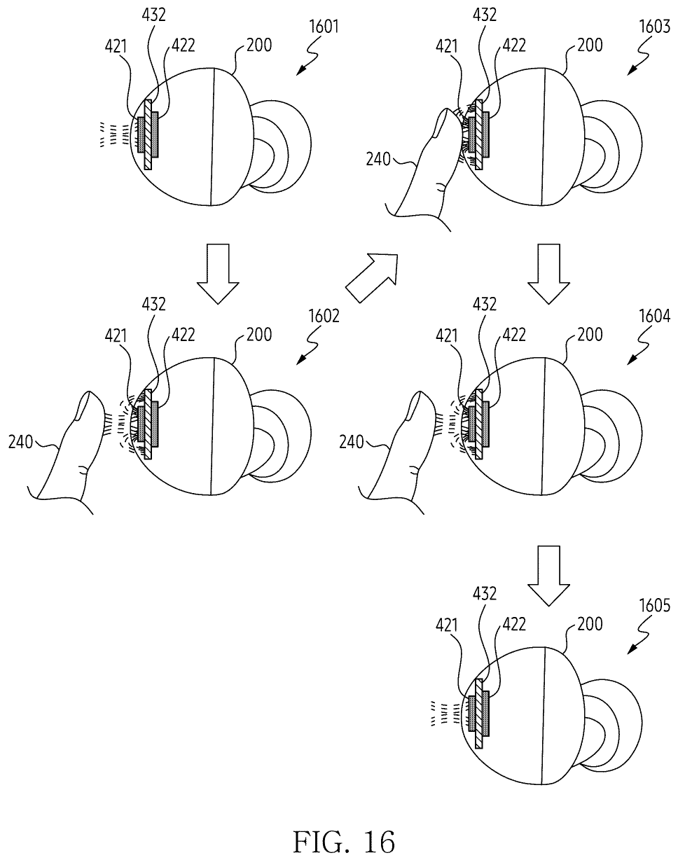

FIG. 16 illustrates an example of an operation of an electronic device according to an embodiment of the disclosure.

An operation of an electronic device 200 illustrated in FIG. 16 may correspond to the operation of the electronic device of FIG. 13A.

Referring to FIG. 16, in a state 1601, a processor 210 may identify (or monitor) a first capacitance value through a first electrode 421. For example, the processor 210 may identify (or monitor) the first capacitance value while a state of a second electrode 422 is in an inactive state.

In a state 1602, the processor 210 may identify that the first capacitance value is greater than a first value. Based on identifying that the first capacitance value is greater than the first value, the processor 210 may identify that a distance between an external object 240 (e.g., a part of a body of a user) and the first electrode 421 is within a reference distance. The processor 210 may identify (or monitor) the first capacitance value and a second capacitance value based on identifying that the distance between the external object 240 and the first electrode 421 is within the reference distance.

The processor 210 may identify that the first capacitance value increases and the second capacitance value decreases. The processor 210 may identify that the external object 240 is the part of the body of the user based on identifying that the first capacitance value increases and the second capacitance value decreases.

In a state 1603, the processor 210 may identify that the first capacitance value is greater than a second value and that the second capacitance value is less than a third value. The processor 210 may identify a touch input by the external object 240 based on identifying that the first capacitance value is greater than the second value and the second capacitance value is less than the third value.

In response to identifying the touch input, the processor 210 may cease identifying the second capacitance value. Based on identifying (or monitoring) only the first capacitance value, the processor 210 may identify whether the touch input is maintained.

In a state 1604, the processor 210 may identify that the first capacitance value is less than or equal to the second value. The processor 210 may identify that the touch input by the external object 240 has been released based on identifying that the first capacitance value is less than or equal to the second value.

For example, the processor 210 may identify the second capacitance value in response to identifying that the first capacitance value is less than or equal to the second value. Based on the first capacitance value and the second capacitance value, the processor 210 may identify whether another touch input distinguished from a received touch input is received.

For example, the processor 210 may identify that the first capacitance value is less than or equal to the first value. The processor 210 may identify that the touch input is terminated based on identifying that the first capacitance value is less than or equal to the first value. As an example, the processor 210 may identify that the distance between the external object 240 and the first electrode 421 deviates from the reference distance based on identifying that the first capacitance value is less than or equal to the first value. The processor 210 may identify that the touch input is terminated based on identifying that the distance between the external object 240 and the first electrode 421 deviates from the reference distance.

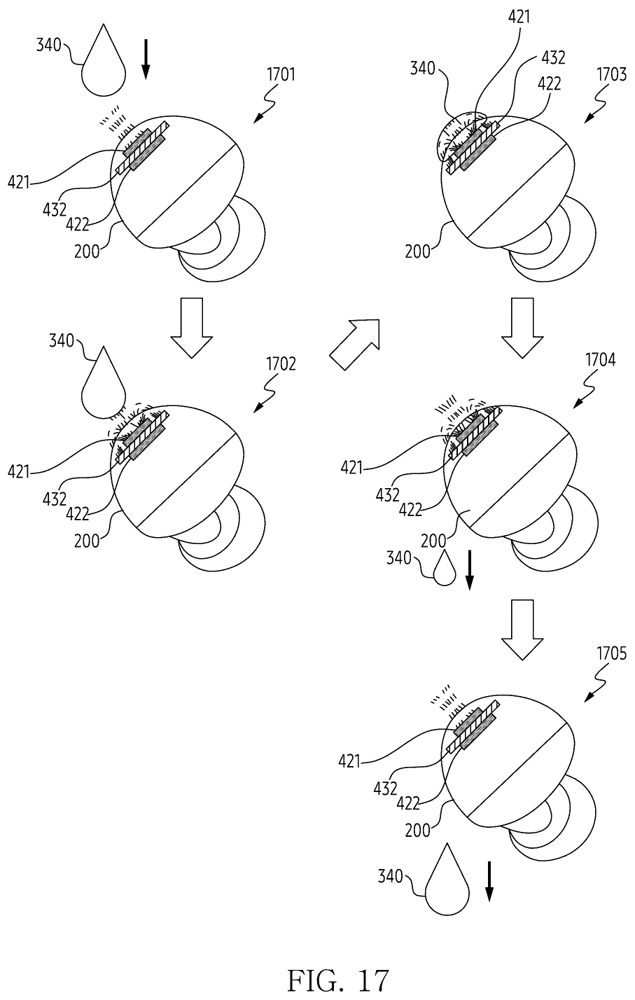

FIG. 17 illustrates an example of an operation of an electronic device according to an embodiment of the disclosure.

Referring to FIG. 17, in a state 1701, a processor 210 may identify (or monitor) a first capacitance value through a first electrode 421. For example, the processor 210 may identify (or monitor) the first capacitance value while a state of a second electrode 422 is in an inactive state.

In a state 1702, the processor 210 may identify that the first capacitance value is greater than a first value. The processor 210 may identify that a distance between a foreign substance 340 (e.g., water) including moisture and the first electrode 421 is within a reference distance based on identifying that the first capacitance value is greater than the first value. The processor 210 may identify (or monitor) the first capacitance value and a second capacitance value based on identifying that a distance between an external object 240 and the first electrode 421 is within the reference distance.

The processor 210 may identify that the first capacitance value and the second capacitance value increase. Based on identifying that the first capacitance value and the second capacitance value increase, the processor 210 may identify that the foreign substance 340 that is not a part of a body of a user approaches.

In a state 1703, the foreign substance 340 may be contacted with the electronic device 200. The processor 210 may identify that the first capacitance value is greater than a second value. The processor 210 may identify that the second capacitance value is greater than a fourth value. The processor 210 may identify that the foreign substance 340 is in contact with the electronic device 200 based on identifying that the first capacitance value is greater than the second value and the second capacitance value is greater than the fourth value. For example, the second value may mean a reference value for identifying whether an external object is contacted based on the first capacitance value. The fourth value may mean a reference value for identifying whether the contacted external object is a foreign substance based on the second capacitance value.

In a state 1704, the processor 210 may identify that the first capacitance value is less than or equal to the second value. Based on identifying that the first capacitance value is less than or equal to the second value, the processor 210 may cease identifying second capacitance. The processor 210 may identify that a portion of the foreign substance 340 has fallen from the electronic device 200.

In a state 1705, it may be identified that the first capacitance value is less than or equal to the first value. Based on identifying that the first capacitance value is less than or equal to the first value, the processor 210 may identify that all of the foreign substance 340 has fallen (or has been removed) from the electronic device 200. According to an embodiment, since the foreign substance 340 includes moisture, the processor 210 may identify that the foreign substance 340 (at least a portion of the foreign substance 340) is dried on a surface of the electronic device 200 based on identifying that the first capacitance value is less than or equal to the first value.

According to an embodiment, an electronic device (e.g., the electronic device 200) may comprise a substrate (e.g., the substrate 432) comprising a first surface and a second surface opposite to the first surface, a first electrode (e.g., the first electrode 421) on a first area having a first size in the first surface, a second electrode (e.g., the second electrode 422) on a second area having a second size greater than the first size in the second surface, touch sensor circuitry (e.g., the touch sensor circuitry 220) connected with the first electrode and the second electrode, at least one processor (e.g., the processor 210) comprising processing circuitry, and memory (e.g., the memory 132) comprising one or more storage media, storing instructions. The instructions, when executed by the at least one processor individually or collectively, may cause the electronic device to identify, based on a first capacitance value identified through the first electrode, that a distance between an external object and the first electrode is within a reference distance. The instructions, when executed by the at least one processor individually or collectively, may cause the electronic device to change, based on identifying that the distance between the external object and the first electrode is within the reference distance, a state of the second electrode from an inactive state to an active state. The instructions, when executed by the at least one processor individually or collectively, may cause the electronic device to identify, based on a first capacitance value and a second capacitance value identified through the first electrode and the second electrode, a touch input by the external object. The instructions, when executed by the at least one processor individually or collectively, may cause the electronic device to identify, based on a first capacitance value, whether the touch input is maintained.

According to an embodiment, the instructions, when executed by the at least one processor individually or collectively, may cause the electronic device to change the state of the second electrode from the active state to the inactive state in response to the touch input.

According to an embodiment, the instructions, when executed by the at least one processor individually or collectively, may cause the electronic device to change the state of the second electrode from the inactive state to the active state based on applying a reference signal to the second electrode.

According to an embodiment, the instructions, when executed by the at least one processor individually or collectively, may cause the electronic device to change the state of the second electrode from the active state to the inactive state based on ceasing to apply the reference signal to the second electrode.

According to an embodiment, the instructions, when executed by the at least one processor individually or collectively, may cause the electronic device to identify a capacitance value identified between the first electrode and the second electrode as a second capacitance value while the reference signal is applied to the second electrode. The instructions, when executed by the at least one processor individually or collectively, may cause the electronic device to identify a capacitance value identified between the first electrode and the external object as a first capacitance value while the reference signal is not applied to the second electrode.

According to an embodiment, the first area where the first electrode is disposed may correspond to the second area where the second electrode is disposed.

According to an embodiment, the second electrode may be configured to shield at least a portion of an electromagnetic wave emitted toward the substrate from at least one component faced away from the second surface.

According to an embodiment, the instructions, when executed by the at least one processor individually or collectively, may cause the electronic device to identify that both a first capacitance value and a second capacitance value increase while the state of the second electrode is the active state. The instructions, when executed by the at least one processor individually or collectively, may cause the electronic device to identify, based on identifying that both a first capacitance value and a second capacitance value increase, that the external object is distinguished from a part of a body of a user of the electronic device.

According to an embodiment, the instructions, when executed by the at least one processor individually or collectively, may cause the electronic device to identify that a first capacitance value increases and a second capacitance value decreases while the state of the second electrode is the active state. The instructions, when executed by the at least one processor individually or collectively, may cause the electronic device to, based on identifying that a first capacitance value increases and a second capacitance value decreases, identify the external object as the part of the body of the user.

According to an embodiment, the instructions, when executed by the at least one processor individually or collectively, may cause the electronic device to identify, based on identifying that a first capacitance value is greater than a first value, that the distance between the external object and the first electrode is within the reference distance.

According to an embodiment, the instructions, when executed by the at least one processor individually or collectively, may cause the electronic device to identify the touch input by the external object based on identifying that a first capacitance value is greater than a second value, which is greater than the first value, and a second capacitance value is less than a third value.

According to an embodiment, the instructions, when executed by the at least one processor individually or collectively, may cause the electronic device to identify, based on identifying that a first capacitance value is changed to less than or equal to the second value, that the touch input is not maintained. The instructions, when executed by the at least one processor individually or collectively, may cause the electronic device to change, based on identifying that the touch input is not maintained, the state of the second electrode from the inactive state to the active state.

According to an embodiment, the instructions, when executed by the at least one processor individually or collectively, may cause the electronic device to identify, based on a first capacitance value and a second capacitance value, another touch input by the external object. The instructions, when executed by the at least one processor individually or collectively, may cause the electronic device to identify that a time interval between a first timing when the touch input is identified and a second timing that the another touch input is identified is within a reference time interval. The instructions, when executed by the at least one processor individually or collectively, may cause the electronic device to identify, based on identifying that the time interval between the first timing and the second timing is within the reference time interval, the touch input and the another touch input as a double tap input.

According to an embodiment, the instructions, when executed by the at least one processor individually or collectively, may cause the electronic device to identify, based on identifying that a first capacitance value is changed to be greater than or equal to the first value, that the distance between the external object and the first electrode deviates from the reference distance.

According to an embodiment, the instructions, when executed by the at least one processor individually or collectively, may cause the electronic device to change, based on identifying that that the distance between the external object and the first electrode deviates from the reference distance, the state of the second electrode from the active state to the inactive state.

According to an embodiment, a method performed by an electronic device (e.g., the electronic device 200) may comprise identifying, based on a first capacitance value identified through a first electrode (e.g., the first electrode 421) of the electronic device, that a distance between an external object and the first electrode is within a reference distance. The method may comprise changing, based on identifying that the distance between the external object (e.g., the external object 240) and the first electrode is within the reference distance, a state of a second electrode (e.g., the second electrode 422) of the electronic device from an inactive state to an active state. The method may comprise identifying, based on a first capacitance value and a second capacitance value identified through the first electrode and the second electrode, a touch input by the external object. The method may comprise identifying, based on a first capacitance value, whether the touch input is maintained.

According to an embodiment, the method may comprise identifying that both a first capacitance value and a second capacitance value increase while the state of the second electrode is the active state. The method may comprise identifying, based on identifying that both a first capacitance value and a second capacitance value increase, that the external object is distinguished from a part of a body of a user of the electronic device.

According to an embodiment, the method may comprise identifying that a first capacitance value increases and a second capacitance value decreases while the state of the second electrode is the active state. The method may comprise, based on identifying that a first capacitance value increases and a second capacitance value decreases, identifying the external object as the part of the body of the user.

According to an embodiment, the method may comprise identifying, based on identifying that a first capacitance value is greater than a first value, that the distance between the external object and the first electrode is within the reference distance.

According to an embodiment, the method may comprise identifying the touch input by the external object based on identifying that a first capacitance value is greater than a second value, which is greater than the first value, and a second capacitance value is less than a third value.

According to an embodiment, a non-transitory computer readable storage medium may store one or more programs. The one or more programs may comprise instructions, which, when executed by a processor of an electronic device with touch sensor circuitry connected with a first electrode and a second electrode, cause the electronic device to identify, based on a first capacitance value identified through the first electrode, that a distance between an external object and the first electrode is within a reference distance. The one or more programs may comprise instructions, which, when executed by the at least one processor, cause the electronic device to change, based on identifying that the distance between the external object and the first electrode is within the reference distance, a state of the second electrode from an inactive state to an active state. The one or more programs may comprise instructions, which, when executed by the at least one processor, cause the electronic device to identify, based on a first capacitance value and a second capacitance value identified through the first electrode and the second electrode, a touch input by the external object. The one or more programs may comprise instructions, which, when executed by the at least one processor, cause the electronic device to identify, based on a first capacitance value, whether the touch input is maintained.

According to the above-described embodiments, the processor 210 may identify a touch input by using both a self capacitance system and a mutual capacitance system. The processor 210 may reduce current consumption by ceasing use of the mutual capacitance system after the touch input is identified. That is, the self capacitance system with high sensitivity is normally used, and the mutual capacitance system may be additionally used in a case that an external object enters within a reference distance. The processor 210 may identify whether an object approaching the electronic device 200 is a part of a body of a user or a foreign substance by using both the self capacitance system and the mutual capacitance system.

According to the above-described embodiments, the first electrode 421 and the second electrode 422 may be disposed to be positioned opposite to each other based on the substrate 432. Since the first electrode 421 and the second electrode 422 are positioned opposite to each other based on the substrate 432, the self capacitance system and the mutual capacitance system may provide substantially the same touch area. Therefore, space efficiency may be improved.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a substrate comprising a first surface and a second surface opposite to the first surface;
a first electrode on a first area having a first size in the first surface;
a second electrode on a second area having a second size greater than the first size in the second surface;
touch sensor circuitry connected with the first electrode and the second electrode;
memory, comprising one or more storage media, storing instructions; and
at least one processor comprising processing circuitry communicatively coupled to the touch sensor circuitry and the memory,
wherein the instructions, when executed by the at least one processor individually or collectively, cause the electronic device to:
identify, based on a first capacitance value identified through the first electrode, that a distance between an external object and the first electrode is within a reference distance,
change, based on identifying that the distance between the external object and the first electrode is within the reference distance, a state of the second electrode from an inactive state to an active state,
identify, based on a first capacitance value and a second capacitance value identified through the first electrode and the second electrode, a touch input by the external object, and
identify, based on a first capacitance value, whether the touch input is maintained.

2. The electronic device of claim 1, wherein the instructions, when executed by the at least one processor individually or collectively, further cause the electronic device to:
change the state of the second electrode from the active state to the inactive state in response to the touch input.

3. The electronic device of claim 2, wherein the instructions, when executed by the at least one processor individually or collectively, further cause the electronic device to:
change the state of the second electrode from the inactive state to the active state based on applying a reference signal to the second electrode.

4. The electronic device of claim 3, wherein the instructions, when executed by the at least one processor individually or collectively, further cause the electronic device to:
change the state of the second electrode from the active state to the inactive state based on ceasing to apply the reference signal to the second electrode.

5. The electronic device of claim 3, wherein the instructions, when executed by the at least one processor individually or collectively, further cause the electronic device to:
identify a capacitance value identified between the first electrode and the second electrode as a second capacitance value while the reference signal is applied to the second electrode, and
identify a capacitance value identified between the first electrode and the external object as a first capacitance value while the reference signal is not applied to the second electrode.

6. The electronic device of claim 1, wherein the first area where the first electrode is disposed corresponds to the second area where the second electrode is disposed.

7. The electronic device of claim 6, wherein the second electrode is configured to shield at least a portion of an electromagnetic wave emitted toward the substrate from at least one component faced away from the second surface.

8. The electronic device of claim 1, wherein the instructions, when executed by the at least one processor individually or collectively, further cause the electronic device to:
identify that both a first capacitance value and a second capacitance value increase while the state of the second electrode is the active state, and
identify, based on identifying that both a first capacitance value and a second capacitance value increase, that the external object is distinguished from a part of a body of a user of the electronic device.

9. The electronic device of claim 8, wherein the instructions, when executed by the at least one processor individually or collectively, further cause the electronic device to:
identify that a first capacitance value increases and a second capacitance value decreases while the state of the second electrode is the active state, and
based on identifying that a first capacitance value increases and a second capacitance value decreases, identify the external object as the part of the body of the user.

10. The electronic device of claim 1, wherein the instructions, when executed by the at least one processor individually or collectively, further cause the electronic device to:
identify, based on identifying that a first capacitance value is greater than a first value, that the distance between the external object and the first electrode is within the reference distance.

11. The electronic device of claim 10, wherein the instructions, when executed by the at least one processor individually or collectively, further cause the electronic device to:
identify the touch input by the external object based on identifying that a first capacitance value is greater than a second value, which is greater than the first value, and a second capacitance value is less than a third value.

12. The electronic device of claim 11, wherein the instructions, when executed by the at least one processor individually or collectively, further cause the electronic device to:
identify, based on identifying that a first capacitance value is changed to less than or equal to the second value, that the touch input is not maintained, and
change, based on identifying that the touch input is not maintained, the state of the second electrode from the inactive state to the active state.

13. The electronic device of claim 11, wherein the instructions, when executed by the at least one processor individually or collectively, further cause the electronic device to:
identify, based on a first capacitance value and a second capacitance value, another touch input by the external object,
identify that a time interval between a first timing when the touch input is identified and a second timing that the another touch input is identified is within a reference time interval, and
identify, based on identifying that the time interval between the first timing and the second timing is within the reference time interval, the touch input and the another touch input as a double tap input.

14. A method performed by an electronic device, the method comprising:
identifying, based on a first capacitance value identified through a first electrode of the electronic device, that a distance between an external object and the first electrode is within a reference distance;
changing, based on identifying that the distance between the external object and the first electrode is within the reference distance, a state of a second electrode of the electronic device from an inactive state to an active state;
identifying, based on a first capacitance value and a second capacitance value identified through the first electrode and the second electrode, a touch input by the external object; and
identifying, based on a first capacitance value, whether the touch input is maintained.

15. The method of claim 14, further comprising:
changing the state of the second electrode from the active state to the inactive state in response to the touch input.

16. The method of claim 15, further comprising:
changing the state of the second electrode from the inactive state to the active state based on applying a reference signal to the second electrode.

17. The method of claim 16, further comprising:
changing the state of the second electrode from the active state to the inactive state based on ceasing to apply the reference signal to the second electrode.

18. The method of claim 14,
wherein the first electrode is disposed on a first surface of a substrate, and
wherein the second electrode is disposed on a second surface of the substrate.

19. The method of claim 18,
wherein the first electrode is disposed on a first area having a first size in the first surface, and
wherein the second electrode is disposed on a second area having a second size in the second surface.

20. One or more non-transitory computer readable storage media storing one or more programs, wherein the one or more programs including computer-executable instructions, that, when executed by at least one processor of an electronic device individually or collectively, the at least one processor with a touch sensor circuitry connected with a first electrode and a second electrode, cause the electronic device to perform operations, the operations comprising:
identifying, based on a first capacitance value identified through the first electrode, that a distance between an external object and the first electrode is within a reference distance;
changing, based on identifying that the distance between the external object and the first electrode is within the reference distance, a state of the second electrode from an inactive state to an active state;
identifying, based on a first capacitance value and a second capacitance value identified through the first electrode and the second electrode, a touch input by the external object; and
identifying, based on a first capacitance value, whether the touch input is maintained.
